(19) United States
(12) Patent Application Publication
(10) Pub. No.: US 2016/0187739 A1
(43) Pub. Date: Jun. 30, 2016

(54) LIQUID CRYSTAL DISPLAY DEVICE

(71) Applicant: SHARP KABUSHIKI KAISHA, Osaka (JP)

(72) Inventors: Yosuke IWATA, Osaka (JP); Mitsuhiro MURATA, Osaka (JP); Kouhei TANAKA, Osaka (JP); Tadashi OHTAKE, Osaka (JP); Ryo YONEBAYASHI, Osaka (JP)

(73) Assignee: Sharp Kabushiki Kaisha, Osaka (JP)

(21) Appl. No.: 14/908,490

(22) PCT Filed: Jul. 24, 2014
(86) PCT No.: PCT/JP2014/069546

§ 371 Date: Jan. 28, 2016

(30) Foreign Application Priority Data
Jul. 29, 2013 (JP) 2013-157083

(51) Int. Cl. G02F 1/1343; G02F 1/1368

(52) U.S. Cl. CPC G02F 1/134309; G02F 1/1368

(57) ABSTRACT

A liquid crystal display device includes: a first substrate; a second substrate facing the first substrate; and a liquid crystal layer sandwiched between the first substrate and the second substrate. The first substrate has thereon a first planar electrode, a first dielectric layer on the first planar electrode, and a pair of comb-shaped electrodes on the first dielectric layer. The second substrate has thereon a second planar electrode and a second dielectric layer on the second planar electrode. The liquid crystal layer includes liquid crystal molecules having a positive dielectric anisotropy. The liquid crystal display device is configured such that, when displaying a minimum gradation, a same voltage is applied to the pair of comb-shaped electrodes, and a relationship among voltages applied to the first planar electrode, the pair of comb-shaped electrodes, and the second planar electrode satisfies a prescribed relational expression.

### TECHNICAL FIELD

The present invention relates to a liquid crystal display device. More specifically, the present invention relates to a liquid crystal display device having an electrode configuration that controls orientation of liquid crystal molecules via an electric field during both a period (hereafter referred to as “a rise”) of changing from a low gradation display state (a black display state) to a high gradation display state (a white display state), and a period (hereafter referred to as “a fall”) of changing from a high gradation display state (a white display state) to a low gradation display state (a black display state).

### BACKGROUND ART

Liquid crystal display devices, in which liquid crystal display elements are sandwiched between a pair of glass substrates or the like, take advantage of being thin, lightweight, and consuming a low amount of power, and are now used in various types of devices that have become indispensable in business and everyday life. These devices include mobiles devices and various types of monitors, televisions, and the like. In recent years, liquid crystal display devices have become widely used in electronic books, photo frames, IAs (industrial appliances), PCs (personal computers), tablet PCs, smartphones, and the like. Liquid crystal display devices of various modes, which are determined by electrode arrangement and substrate design, that change the optical properties of a liquid crystal layer have been investigated for use in the devices mentioned above. Examples of such are given below.

Patent Document 1, for example, discloses a liquid crystal device that includes: a first substrate and a second substrate that are disposed so as to face each other and sandwich liquid crystal therebetween; a first electrode and a second electrode disposed on the first substrate so as to face the liquid crystal layer, and a third electrode disposed on the second substrate so as to face the liquid crystal layer. The orientation state of the liquid crystal during a rising response period is controlled by a vertical electric field generated between the first/second electrode and the third electrode, and the orientation state of the liquid crystal during a falling response period is controlled by a horizontal electric field generated between the first electrode and the second electrode.

### RELATED ART DOCUMENT

### Patent Document

Patent Document 1: Japanese Patent Application Laid-Open Publication No. 2007-101972

### SUMMARY OF THE INVENTION

### Problems to be Solved by the Invention

The above-mentioned Patent Document 1 discloses a liquid crystal device that realizes a fast response speed by shortening, in particular, the falling response period part of the response time of the liquid crystal device. However, the invention disclosed in Patent Document 1 does not have an electrode for adjusting differences in voltage with the above-mentioned first and second electrodes (which correspond to a pair of comb-shaped electrodes 108a, 108b that will be explained later) on the above-mentioned first substrate (which corresponds to a lower substrate 113 that will be explained later). As a result, the invention is unable to prevent the formation of an oblique electric field during black display, which means that the liquid crystal molecules will rotate, resulting in the invention not being able to sufficiently suppress light leakage during black display. This in turn leads to a decrease in contrast.

The above-mentioned problems will be explained using a conventional liquid crystal display device 101, such as that shown in FIG. 18, for example. FIG. 18 is a schematic cross-sectional view of a pixel of a conventional liquid crystal display device.

As shown in FIG. 18, the liquid crystal display device 101 includes: a lower substrate 113; an upper substrate 114 that faces the lower substrate 113; and a liquid crystal layer 115 sandwiched between the lower substrate 113 and the upper substrate 114. Liquid crystal molecules included in the liquid crystal layer 115 have a positive dielectric anisotropy (Δ∈>0).

As shown in FIG. 18, the lower substrate 113 includes: a supporting substrate 110a; an insulating layer 111a formed on top of the supporting substrate 110a on a liquid crystal layer 115 side of the supporting substrate 110a; and the pair of comb-shaped electrodes 108a, 108b, which are formed on top of the insulating substrate 111a on a liquid crystal layer 115 side of the insulating layer 111a. The pair of comb-shaped electrodes 108a, 108b are formed in the same layer. Furthermore, a vertical alignment film 112a is disposed between the liquid crystal layer 115 and the pair of comb-shaped electrodes 108a, 108b/the insulating layer 111a.

As shown in FIG. 18, the upper substrate 114 includes: a supporting substrate 110b; a planar opposite electrode 109 formed on the supporting substrate 110b on a liquid crystal layer 115 side of the supporting substrate 110b; and an insulating layer 111b formed on the opposite electrode 109 on a liquid crystal layer 115 side of the opposite electrode 109. In addition, a vertical alignment film 112b is disposed between the insulating layer 111b and the liquid crystal layer 115.

The vertical alignment films 112a, 112b align the liquid crystal molecules included in the liquid crystal layer 115 in a direction perpendicular to respective main surfaces of the lower substrate 113 and the upper substrate 114 when no voltage is being applied.

In FIG. 18, (ii)′, (iii)′, and (iv)′ respectively represent the voltages applied to the comb-shaped electrode 108a, the comb-shaped electrode 108b, and the opposite electrode 109. (ii)′ −V1′/V1′, which is the applied voltage of the comb-shaped electrode 108a, and (iii)′ V1′/−V1′, which is the applied voltage of the comb-shaped electrode 108b, respectively indicate that, during black display and white display, the pair of comb-shaped electrodes 108a, 108b are alternating current (AC) driven by applying voltages V1′ of opposite polarity to the pair of comb-shaped electrodes 108a, 108b. In the conventional liquid crystal display device 101, gradation display is performed by changing the value of V1′. V1′ is 0V during black display and 6V during white display, for example. In addition, the applied voltage (iv)′ 7.5V/−7.5V of the opposite electrode 109 indicates that the opposite electrode 109 is AC driven in phase with the comb-shaped electrode 108b by applying a voltage of 7.5V to the opposite electrode 109 during black display and white display.

FIG. 19 shows the director distribution, the transmittance distribution, and the electric field distribution during black display of the conventional liquid crystal display device. FIG. 19 is a simulation conducted for a liquid crystal display device 101 such as that shown in FIG. 18. FIG. 19 is a simulation of an electric field distribution (equipotential surface) 116i, a distribution of directors 117i, and a transmittance distribution 118i during black display, where the applied voltages (ii)′, (iii)′ of the pair of comb-shaped electrodes 108a, 108b are both set to 0V (black display), and the applied voltage (iv)′ of the opposite electrode 109 is set to 7.5V (which corresponds to V=7.5000V in FIG. 19). FIG. 19 was created using an LCD Master manufactured by Shintech Inc.

The correspondence between the values shown on the horizontal axis, left vertical axis, and right vertical axis in FIG. 19 and the location of respective members shown in FIG. 18 will be explained below. Looking at the horizontal axis in FIG. 19, the values from 0.000 μm to 1.300 μm represent a region where the left-hand portion of the comb-shaped electrode 108a exists, the values from 1.300 μm to 4.800 μm represent a region between the left-hand portion of the comb-shaped electrode 108a and the comb-shaped electrode 108b, the values from 4.800 μm to 7.400 μm represent a region where the comb-shaped electrode 108b exists, the values from 7.400 μm to 10.900 μm represent a region between the comb-shaped electrode 108b and the right-hand portion of the comb-shaped electrode 108a, and the values from 10.900 μm to 12.200 μm represent a region where the right-hand portion of the comb-shaped electrode 108a exists. Looking at the left vertical axis in FIG. 19, (I)′ 0.000 μm is the location of the interface of the supporting substrate 110a and the insulating layer 111a, (II)′ 0.000 μm is the location of the interface of the insulating layer 111a and the liquid crystal layer 115 (the interface of the insulating layer 111a and the pair of comb-shaped electrodes 108a, 108b), (III)′ 0.000 μm is the location of the interface of the liquid crystal layer 115 and the insulating layer 111b, and (IV)′ 1.500 μm is the location of the interface of the insulating layer 111b and the opposite electrode 109. At (II)′ 0.000 μm and (III)′ 0.000 μm, the thickness of the horizontal alignment films 112a, 112b is negligible; thus, these two locations are essentially the location of the interface of the insulating layer 111a and the liquid crystal layer 115 (the interface of the insulating layer 111a and the pair of comb-shaped electrodes 108a, 108b) and the location of the interface of the liquid crystal layer 115 and the insulating layer 111b, respectively. The right vertical axis in FIG. 19 represents transmittance. The director distribution, transmittance distribution, and electric field distribution (equipotential surface) during black display were simulated for the conventional liquid crystal display device over a region corresponding to the values from 0.000 μm to 12.200 μm on the horizontal axis in FIG. 19.

As shown in FIG. 19, during black display, the equipotential surface between the comb-shaped electrode 108a and the comb-shaped electrode 108b is located much lower (significantly recessed toward the insulating layer 111a) than the equipotential surface on top of the pair of comb-shaped electrodes 108a, 108b. Thus, the vertical electric field between the lower substrate 113 and the upper substrate 114 is not applied uniformly. This leads to the generation of a large oblique electric field component, which results in a significant rotation of the liquid crystal molecules located near the edges of the pair of comb-shaped electrodes 108a, 108b. Regions AR9 in FIG. 19 are examples of a location where this large rotation occurs. As a result, it can be seen in FIG. 19 that the transmittance near the edges of the pair of the comb-shaped electrodes 108a, 108b is larger than the transmittance in other regions. Thus, it is not possible to sufficiently prevent light leakage during black display, which is what caused the drop in contrast. Thus, there was room for improvement for the invention disclosed in Patent Document 1 in regards to resolving the above-mentioned problems.

The present invention was made in light of the above-mentioned circumstances. An aim of the present invention is to provide a liquid crystal display device that: has an electrode structure that controls the alignment of liquid crystal molecules, via an electric field, during both rises and falls; performs vertical electric field (an electric field perpendicular to the main surfaces of the substrates) ON—horizontal electric field (an electric field that is horizontal with respect to the main surfaces of the substrates) ON switching (hereafter referred to as an ON-ON switching mode); and is capable of sufficiently improving contrast.

### Means for Solving the Problems

The inventors investigated various types of ON-ON switching mode liquid crystal display devices in order to find a device that could sufficiently improve contrast, and focused on a three layer electrode structure (the three layers being formed of a common electrode, a pair of comb-shaped electrodes, and an opposite electrode) that included a common electrode that adjusted differences in voltage with the pair of comb-shaped electrodes during black display. The inventors discovered that it was possible to improve contrast since it was possible to sufficiently prevent light leakage during black display as a result of the liquid crystal molecules being sufficiently prevented from rotating by adjusting differences in voltage with the pair of comb-shaped electrodes and preventing the generation of an oblique electric field during black display.

However, upon further investigation, it was learned that there was a drop in contrast when differences in voltage between the electrodes during black display were not optimized in an ON-ON switching mode liquid crystal display device having a three-layer electrode structure. Thus, the inventors investigated various types of ON-ON switching mode liquid crystal display devices having a three-layer electrode structure in order find a device that could sufficiently improve contrast, and focused on a configuration that optimized differences in voltage between the electrodes during black display. The inventors discovered that if differences in voltage between the common electrode and the pair of comb-shaped electrodes, and differences in voltage between the pair of comb-shaped electrodes and the opposite electrode during black display were optimized, the location (height) of the equipotential surface between the pair of comb-shaped electrodes approached the location (height) of the equipotential surface on top of the pair of comb-shaped electrodes, meaning that the vertical electric field between the substrates was applied in a nearly uniform manner, leading to a more even vertical alignment of the liquid crystal molecules and making it possible to sufficiently prevent light leakage during black display. This meant that it was possible to sufficiently improve contrast. In this way, the inventors of the present invention were able to completely resolve the above-mentioned problems and arrive at the present invention.

In other words, according to one aspect, the present invention may be a liquid crystal display device (hereafter referred to as a first liquid crystal display device of the present invention) that includes: a first substrate; a second substrate facing the first substrate; and a liquid crystal layer sandwiched between the first substrate and the second substrate, wherein the first substrate has a first planar electrode, a pair of comb-shaped electrodes, and a first dielectric layer between the first planar electrode and the pair of comb-shaped electrodes, a dielectric layer being essentially absent between the liquid crystal layer and the pair of comb-shaped electrodes and between the liquid crystal layer and the first dielectric layer, wherein the second substrate has a second planar electrode and a second dielectric layer, a dielectric layer being essentially absent between the second dielectric layer and the liquid crystal layer, wherein the liquid crystal layer includes liquid crystal molecules having a positive dielectric anisotropy, and wherein, when displaying a minimum gradation, a relationship among voltages applied to the first planar electrode, the pair of comb-shaped electrodes, and the second planar electrode satisfies the following expressions (1) and (2), where Vₐ (unit: V) is a voltage differential between the voltage of the first planar electrode and the voltage of the pair of comb-shaped electrodes, and V_{b} (unit: V) is a voltage differential between the voltage of the pair of comb-shaped electrodes and the voltage of the second planar electrode.

$$\begin{matrix}< Formula 1 > & \\ 0 < \vert {V}_{a} \vert < 2 \vert {V}_{a \_ 0} \vert - 0.1 & ( 1 ) \\ < Formula 2 > & \\ {V}_{a \_ 0} = \frac{{ɛ}_{‖} {ɛ}_{2} {d}_{1}}{{ɛ}_{1} {ɛ}_{2} {d}_{LC} + {ɛ}_{1} {ɛ}_{‖} {d}_{2}} {V}_{b} & ( 2 )\end{matrix}$$

In expression (1) and expression (2) shown above, ∈₁ is a permittivity of the first dielectric layer, ∈₂ is a permittivity of the second dielectric layer, ∈_{∥} is a permittivity in a direction horizontal with respect to a director of the liquid crystal molecules included in the liquid crystal layer, d₁ is a thickness (unit: μm) of the first dielectric layer, d₂ is a thickness (unit: μm) of the second dielectric layer, and d_{LC} is a thickness (unit: μm) of the liquid crystal layer.

The present invention can also be applied in instances in which the second dielectric layer does not exist.

In other words, according to a different aspect, the present invention may be a liquid crystal display device (hereafter referred to as a second liquid crystal display device of the present invention) that includes: a first substrate; a second substrate facing the first substrate; and a liquid crystal layer sandwiched between the first substrate and the second substrate, wherein the first substrate has a first planar electrode, a pair of comb-shaped electrodes, and a first dielectric layer between the first planar electrode and the pair of comb-shaped electrodes, a dielectric layer being essentially absent between the liquid crystal layer and the pair of comb-shaped electrodes and between the liquid crystal layer and the first dielectric layer, wherein the second substrate has a second planar electrode, a dielectric layer being essentially absent between the second planar electrode and the liquid crystal layer, wherein the liquid crystal layer includes liquid crystal molecules having a positive dielectric anisotropy, and wherein, when displaying a minimum gradation, a relationship among voltages applied to the first planar electrode, the pair of comb-shaped electrodes, and the second planar electrode satisfies the following expressions (1) and (3), where Vₐ (unit: V) is a voltage differential between the voltage of the first planar electrode and the voltage of the pair of comb-shaped electrodes, and V_{b} (unit: V) is a voltage differential between the voltage of the pair of comb-shaped electrodes and the voltage of the second planar electrode.

$$\begin{matrix}< Formula 3 > & \\ 0 < \vert {V}_{a} \vert < 2 \vert {V}_{a \_ 0} \vert - 0.1 & ( 1 ) \\ < Formula 4 > & \\ {V}_{a \_ 0} = \frac{{ɛ}_{‖} {d}_{1}}{{ɛ}_{1} {d}_{LC}} {V}_{b} & ( 3 )\end{matrix}$$

In expression (1) and expression (3) shown above, ∈₁ is a permittivity of the first dielectric layer, ∈_{∥} is a permittivity in a direction that is horizontal with respect to a director of the liquid crystal molecules included in the liquid crystal layer, d₁ is a thickness (unit: μm) of the first dielectric layer, and d_{LC} is a thickness (unit: μm) of the liquid crystal layer.

There are no particular restrictions regarding any of the other constituting components of the first and second liquid crystal display devices of the present invention, and another configuration normally used in liquid crystal display devices may be appropriately applied.

### Effects of the Invention

According to the present invention, it is possible to provide a liquid crystal display device that sufficiently improves contrast in an ON-ON switching mode liquid crystal display device.

### BRIEF DESCRIPTION OF THE DRAWINGS

FIG. 1 is a schematic plan view of a pixel in a liquid crystal display device according to Embodiment 1 and Embodiment 2.

FIG. 2 is schematic cross-sectional view of a liquid crystal display device according to Embodiment 1 that shows a cross-section that corresponds to the line segment a-a′ in FIG. 1.

FIG. 3 is a graph that shows the contrast and normalized luminance during black display in liquid crystal display devices according to Working Examples 1 to 7, and Comparative Examples 1, 2, 3, and 6.

FIG. 4 shows the director distribution, the transmittance distribution, and the electric field distribution during black display in a liquid crystal display device according to Working Example 3.

FIG. 5 shows the director distribution, the transmittance distribution, and the electric field distribution during black display in a liquid crystal display device according to Working Example 4.

FIG. 6 shows the director distribution, the transmittance distribution, and the electric field distribution during black display in a liquid crystal display device according to Comparative Example 1.

FIG. 7 shows the director distribution, the transmittance distribution, and the electric field distribution during black display in a liquid crystal display device according to Comparative Example 3.

FIG. 8 shows the director distribution, the transmittance distribution, and the electric field distribution during black display in a liquid crystal display device according to Comparative Example 4.

FIG. 9 shows the director distribution, the transmittance distribution, and the electric field distribution during black display in a liquid crystal display device according to Comparative Example 5.

FIG. 10 shows the director distribution, the transmittance distribution, and the electric field distribution during black display in a liquid crystal display device according to Comparative Example 6.

FIG. 11 shows the transmittance distribution during black display in the liquid crystal display devices according to Working Examples 3 and 4, and Comparative Examples 1, 3, 4, 5, and 6.

FIG. 12 is a schematic cross-sectional view of the liquid crystal display device according to Embodiment 2 that shows a cross-section that corresponds to the line segment a-a′ in FIG. 1.

FIG. 13 is a graph that shows contrast and normalized luminance during black display for liquid crystal display devices according to Working Examples 8 to 12, and Comparative Examples 8, 9, 11, and 12.

FIG. 14 shows the director distribution, the transmittance distribution, and the electric field distribution during black display for the liquid crystal display device according to Comparative Example 8.

FIG. 15 shows the director distribution, the transmittance distribution, and the electric field distribution during black display for the liquid crystal display device according to Comparative Example 9.

FIG. 16 shows the director distribution, the transmittance distribution, and the electric field distribution during black display for the liquid crystal display device according to Comparative Example 10.

FIG. 17 shows the transmittance distribution during black display for the liquid crystal display devices according to Working Example 10 and Comparative Examples 8 to 10.

FIG. 18 is a schematic cross-sectional view of a pixel in a conventional liquid crystal display device.

FIG. 19 shows the director distribution, the transmittance distribution, and the electric field distribution during black display in the conventional liquid crystal display device.

### DETAILED DESCRIPTION OF EMBODIMENTS

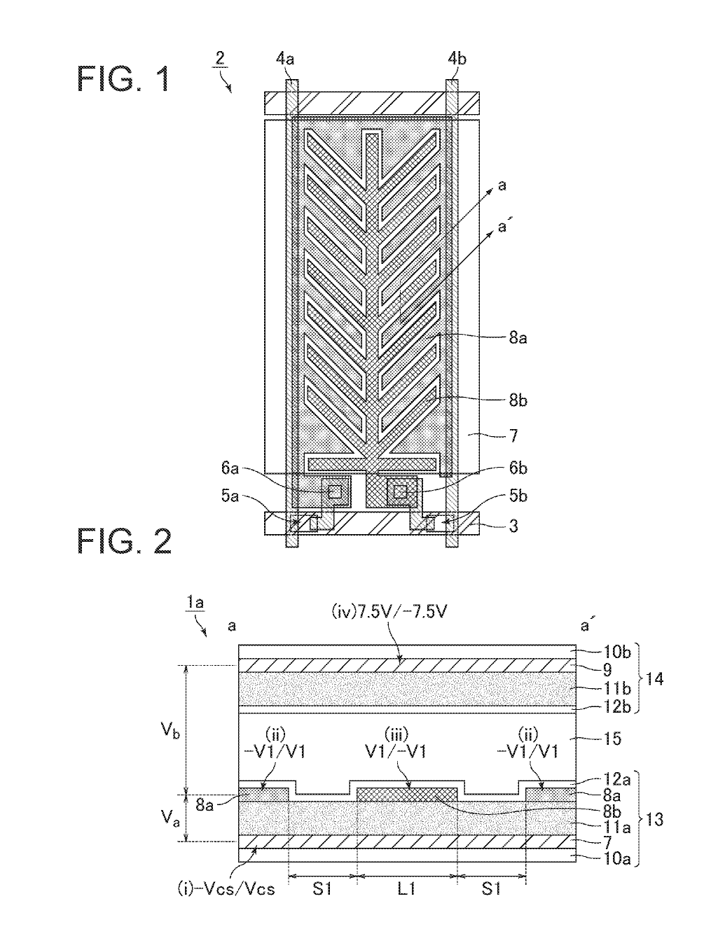

The above-mentioned first and second planar electrodes may be rectangular like a common electrode 7 shown in FIG. 1, or may have a different type of plate-like shape, for example.

The pair of comb-shaped electrodes may be a pair of comb-shaped electrodes that include a plurality of linear portions, and the pair of comb-shaped electrodes may be formed of a combination of a plurality of linear portions and another plurality of linear portions, like a pair of comb-shaped electrodes 8a, 8b shown in FIG. 1, or may be formed of a combination of one linear portion and two linear portions, for example. The pair of comb-shaped electrodes are able to satisfactorily generate a horizontal electric field (an electric field that is horizontal with respect to the respective main surfaces of the first and second substrates) between the pair of comb-shaped electrodes. The phrase “an electric field in a direction that is horizontal with respect to the respective main surfaces of the first and second substrates” includes a configuration that generates an electric field in a direction that is substantially horizontal, as long as it can be said in the technical field of the present invention that the electric field is in a direction that is horizontal with respect to the respective main surfaces of the first and second substrates, for example. It is also possible to suitably generate a fringe electric field between the pair of comb-shaped electrodes and the first planar electrode.

It is also possible to suitably generate a vertical electric field (an electric field in a direction that is perpendicular to the respective main surfaces of the first and second substrates) between the first substrate and the second substrate, via the first planar electrode, the pair of comb-shaped electrodes, and the second planar electrode. The phrase “an electric field in a direction that is perpendicular to the respective main surfaces of the first and second substrates” includes a configuration that generates an electric field in a direction that is substantially perpendicular, as long as it can be said in the technical field of the present invention that the electric field is in a direction that is perpendicular to the respective main surfaces of the first and second substrates, for example.

Thus, it is possible to suitably generate a vertical electric field and a horizontal electric field (or a fringe electric field) such as those described above. In addition, by combining the vertical electric field and the horizontal electric field, it is possible during rising and falling periods to rotate and control the alignment of the liquid crystal molecules included in the liquid crystal layer via the electric fields, and to perform gradation display from a black display state (in which the minimum gradation is displayed) to a white display state (in which the maximum gradation is displayed). In this manner, it is possible to realize a faster response time. The technical significance of the present invention is that the relationship during black display among the voltages of the first planar electrode, the pair of comb-shaped electrodes, and the second planar electrode has been optimized in a liquid crystal display device having the above-mentioned mode, resulting in the present invention exhibiting a unique effect.

According to expression (1), |Vₐ| is greater than 0. This shows that, in the first and second liquid crystal display devices of the present invention, a difference (not 0) in voltage is provided between the first planar electrode and the pair of comb-shaped electrodes. In a liquid crystal display device with a general display mode such as a VA (vertical alignment) mode, an IPS (in-plane switching) mode, or the like, black display is normally performed with a difference in voltage of 0V between a pair of electrodes (such as a pair of electrodes included on a pair of opposing substrates, for example) that apply voltage to a liquid crystal layer, for example. However, the first and second liquid crystal display devices of the present invention are configured with a difference in voltage since a black display state that can sufficiently improve the contrast cannot be obtained when the difference in voltage between the first planar electrode and the pair of comb-shaped electrodes is set to 0V since the vertical electric field and the horizontal electric field will be combined in the manner mentioned above.

As long as the liquid crystal molecules included in the liquid crystal layer have a positive dielectric anisotropy, the long axes of the liquid crystal molecules may be aligned along the lines of electric force when voltage is applied. In this manner, it is easy to control the alignment of the liquid crystal molecules; thus it is possible to realize an even faster response time.

The first liquid crystal display device of the present invention may have the above-mentioned second dielectric layer. In such a case, it is possible to realize a higher transmittance.

The second liquid crystal display device of the present invention may not have the second dielectric layer, or in other words, a dielectric layer may be essentially absent between the second planar electrode and the liquid crystal layer. As a result, compared to the first liquid crystal display device (a configuration having the second dielectric layer) of the present invention, it is possible to apply a stronger vertical electric field when voltage is applied to the second planar electrode, for example, thus making it possible to realize a faster driving speed. In addition, according to the second liquid crystal display device of the present invention, it is possible to simplify the manufacturing process.

In the present specification, “a voltage of a pair of comb-shaped electrodes” refers to the average voltage between the one comb-shaped electrode and the other comb-shaped electrode of the pair of comb-shaped electrodes.

Embodiments (working examples) are shown below and the present invention is described in further detail with reference to the drawings, but the present invention is not limited to these embodiments (working examples). In addition, the various configurations in the embodiments (working examples) described below may be appropriately combined or changed within a scope that does not depart from the gist of the present invention.

### Embodiment 1

Embodiment 1 is a liquid crystal display device in which, in the first liquid crystal liquid crystal display device of the present invention, a voltage of 7.5V is applied to the second planar electrode and the second planar electrode is AC driven.

FIG. 1 is a schematic plan view of one pixel of the liquid crystal display device according to Embodiment 1. As shown in FIG. 1, inside a pixel 2 in the liquid crystal display device according to Embodiment 1, a voltage provided from a source bus line 4a is applied to a comb-shaped electrode 8a, which is one of a pair of comb-shaped electrodes, via a thin film transistor element 5a and a contact hole 6a when the electrode is selected by a gate bus line 3. In addition, a voltage provided by a source bus line 4b is applied to a comb-shaped electrode 8b, which is the other of the pair of comb-shaped electrodes, via a thin film transistor element 5b and a contact hole 6b when the electrode is selected by the gate bus line 3. The common electrode 7 is a planar electrode. FIG. 1 mainly shows the lower substrate 13, which will be described later. In practice, the upper substrate 14, which will be described later, faces the lower substrate 13 and has a planar opposite electrode 9, which will be explained later. In addition, as shown in FIG. 1, the pair of comb-shaped electrodes 8a, 8b are diagonal with respect to the source bus line 4a (the source bus line 4b), the common electrode 7 has a rectangular shape, and the pixel 2 has a rectangular shape. However, as long as these members exhibit the effect of the present invention, they may have a shape different from that mentioned above. The same also applies to the shape of the opposite electrode 9.

FIG. 2 is schematic cross-sectional view of a liquid crystal display device according to Embodiment 1 that shows a cross-section that corresponds to the line segment a-a′ in FIG. 1. As shown in FIG. 2, a liquid crystal display device 1a includes: the lower substrate 13; the upper substrate 14, which faces the lower substrate 13; and a liquid crystal layer 15 sandwiched between the lower substrate 13 and the upper substrate 14. Liquid crystal molecules included in the liquid crystal layer 15 have a positive dielectric anisotropy (Δ∈>0).

There are no particular restrictions regarding the thickness of the liquid crystal layer 15; however, it is preferable that the layer thickness be between 2 μm and 7 μm. This is the range of values believed to be suitable when considering yield, properties, and the like.

As shown in FIG. 2, the lower substrate 13 includes: a supporting substrate 10a; the planar common electrode 7 formed on top of the supporting substrate 10a on the liquid crystal layer 15 side of the supporting substrate 10a; an insulating layer 11a formed on top of the common electrode 7 on the liquid crystal layer 15 side of the common electrode 7; and the pair of comb-shaped electrodes 8a, 8b formed on top of the insulating layer 11a on the liquid crystal layer 15 side of the insulating layer 11a. The pair of comb-shaped electrodes 8a, 8b are formed in the same layer. In addition, a vertical alignment film 12a is disposed between the liquid crystal layer 15 and the pair of comb-shaped electrodes 8a, 8b/the insulating layer 11a.

It is preferable to use transparent electrodes made of ITO (indium tin oxide), IZO (indium zinc oxide), or the like, for example, as the common electrode 7 and the pair of comb-shaped electrodes 8a, 8b.

The insulating layer 11a may be an organic insulating film or an inorganic insulating film, for example. There are no particular restrictions regarding the permittivity of the insulating layer 11a; however it is preferable that the permittivity be greater than 1 and less than or equal to 10. This is the range of values believed to suitable when considering yield, properties, and the like. There are no particular restrictions regarding the thickness of the insulating layer 11a; however, it is preferable that the layer thickness be between 0.1 μm and 3 μm. This is the range of values believed to suitable when considering yield, properties, and the like.

There are no particular restrictions regarding an electrode width L1 of the comb-shaped electrode 8b shown in FIG. 2; however, it is preferable that the electrode width be greater than or equal to 2 μm. The restrictions and preferences regarding an electrode width (not shown) of the comb-shaped electrode 8a are the same as those mentioned above for the electrode width L1 of the comb-shaped electrode 8b. If the electrode width L1 is less than 2 μm, there is a chance that problems such as leaks and disconnection may occur. There are also no particular restrictions regarding an electrode gap width S1, such as that shown in FIG. 2, between the comb-shaped electrode 8a and the comb-shaped electrode 8b; however, it is preferable that this gap be between 2 μm and 7 μm. This is the range of values believed to suitable when considering properties and the like.

As shown in FIG. 2, the upper substrate 14 includes: a supporting substrate 10b; the planar opposite electrode 9, which is formed on top of the supporting substrate 10b on the liquid crystal layer 15 side of the supporting substrate 10b; and an insulating layer 11b formed on top of the opposite electrode 9 on the liquid crystal layer side 15 of the opposite electrode 9. Furthermore, a vertical alignment film 12b is disposed between the insulating layer 11b and the liquid crystal layer 15.

It is preferable to use a transparent electrode made of ITO, IZO, or the like, for example, as the opposite electrode 9.

The insulating layer 11b may be an organic insulating film or an inorganic insulating film, for example. There are no particular restrictions regarding the permittivity of the insulating layer 11b; however it is preferable that the permittivity be greater than 1 and less than or equal to 10. This is the range of values believed to suitable when considering properties and the like. There are no particular restrictions regarding the thickness of the insulating layer 11b; however it is preferable that the thickness be greater than 0 μm and less than or equal to 4 μm. This is the range of values believed to suitable when considering properties and the like.

The vertical alignment films 12a, 12b align the liquid crystal molecules included in the liquid crystal layer 15 in a direction perpendicular to the respective main surfaces of the lower substrate 13 and upper substrate 14 when voltage is not being applied. As long the vertical alignment films align the liquid crystal molecules included in the liquid crystal layer 15 in a direction perpendicular to the respective main surfaces of the lower substrate 13 and the upper substrate 14 when voltage is not being applied, an organic alignment film or an inorganic alignment film may be used for the vertical alignment films, for example. As an example of a method of forming the vertical alignment films, the vertical alignment films may be formed on the lower substrate 13 and the upper substrate 14 so as to function as vertical alignment films by applying a liquid crystal alignment agent for forming the vertical alignments films via the inkjet method or spin-coating, printing (transcribing) the alignment agent via the flexographic method, and carrying out the subsequent steps (a step of baking or the like, for example). The formation conditions of the vertical alignment films may be appropriately set in accordance with the method of forming the vertical alignment film and the like. The thickness and the like of the vertical alignment films may be configured so as to be the normally-used values for the thickness and the like of vertical alignment films. Various types of alignment treatment may be performed on the vertical alignment films. Examples of methods for performing alignment treatment include rubbing, photoalignment, and the like. The lower substrate 13 and the upper substrate 14 may be substrates upon which treatment for forming the vertical alignment films was performed, and may be substrates upon which a variety of treatments were performed.

It is preferable that the supporting substrates 10a, 10b be insulating substrates composed of a glass, a resin, or the like, for example. A transparent substrate such as a glass substrate or a plastic substrate can be suitably used.

The liquid crystal display device 1a further includes a pair of linearly polarizing plates (not shown) on respective sides of the supporting substrate 10a and the supporting substrate 10b opposite to the liquid crystal layer 15. A pair of circularly polarizing plates may be used instead of the pair of linearly polarizing plates.

In the liquid crystal display device 1a according to Embodiment 1, while a vertical electric field is applied to the liquid crystal layer 15 via a difference in voltage between the lower substrate 13 and the upper substrate 14 (a difference in voltage between the opposite electrode 9 and the common electrode 7/the pair of comb-shaped electrodes 8a, 8b), a horizontal electric field is applied to the liquid crystal layer 15 by generating a difference in voltage between the comb-shaped electrode 8a and the comb-shaped electrode 8b by applying voltages with polarities opposite to each other. By combining the vertical electric field and the horizontal electric field, the liquid crystal molecules included in the liquid crystal layer 15 are rotated and the alignment thereof is controlled via the electric fields during both rises and falls, and gradation display is performed from a black display state to a white display state. In this manner, it is possible to realize a faster response time.

In FIG. 2, (i), (ii), (iii), and (iv) represent the applied voltages of the common electrode 7, the comb-shaped electrode 8a, the comb-shaped electrode 8b, and the opposite electrode 9, respectively. The applied voltage (ii) −V1/V1 of the comb-shaped electrode 8a and the applied voltage (iii) V1/−V1 of the comb-shaped electrode 8b indicate that the comb-shaped electrodes 8a, 8b are driven by applying voltages V1 with polarities opposite to each other during black display and white display. In the liquid crystal display device 1a according to Embodiment 1, gradation display is performed by modifying the value of V1. During black display, V1 is 0V, and during white display, V1 is 6V, for example. The applied voltage (iv) 7.5V/−7.5V of the opposite electrode 9 indicates that, during black display and white display, a voltage of 7.5V is applied to the opposite electrode 9, and the opposite electrode 9 is AC driven in phase with the comb-shaped electrode 8b. The applied voltage (i) −V_{cs}/V_{cs} of the common electrode 7 indicates that, during black display and white display, a voltage V_{cs} that has a polarity opposite to that of the voltage applied to the opposite electrode 9 is applied to the common electrode 7, and the common electrode 7 is then AC driven.

In FIG. 2, Vₐ represents a difference in voltage between the voltage of the common electrode 7 and the voltage of the pair of comb-shaped electrodes 8a, 8b in the liquid crystal display device 1a according to Embodiment 1. For this difference in voltage, the voltage of the common electrode 7 is used as the reference value, and the direction of the arrows represents the positive direction. V_{b} represents a difference in voltage between the voltage of the pair of comb-shaped electrodes 8a, 8b and the voltage of the opposite electrode 9 in the liquid crystal display device 1a according to Embodiment 1. For this difference in voltage, the voltage of the pair of comb-shaped electrodes 8a, 8b is used as the reference value, and the direction of the arrows represents the positive direction. The relationship and the like of Vₐ and V_{b} will be explained later.

The lower substrate 13, the upper substrate 14, the common electrode 7, the pair of comb-shaped electrodes 8a, 8b, the opposite electrode 9, the insulating layer 11a, the insulating layer 11b, and the liquid crystal layer 15 respectively correspond to the first substrate, the second substrate, the first planar electrode, the pair of comb-shaped electrodes, the second planar electrode, the first dielectric layer, the second dielectric layer, and the liquid crystal layer of the first liquid crystal display device of the present invention. In addition, Vₐ and V_{b} shown in FIG. 2 respectively correspond to Vₐ and V_{b} of the first liquid crystal display device of the present invention.

Hereafter, an explanation will be given of working examples in which the liquid crystal display device according to Embodiment 1 was actually manufactured.

### Working Example 1

In Working Example 1, the applied voltage (i) of the common electrode 7 is −0.4V/0.4V (corresponding to instances in which V_{cs}=0.4V). During black display and white display, a voltage having a polarity opposite to the applied voltage (iv) 7.5V/−7.5V of the opposite electrode 9 is applied to the common electrode 7, and the common electrode is then AC driven. As mentioned above, for the applied voltages (ii), (iii) of the pair of comb-shaped electrodes 8a, 8b, V1 is set to 0V during black display and 6V during white display.

In Working Example 1, the liquid crystal molecules included in the liquid crystal layer 15 have a positive dielectric anisotropy. The dielectric anisotropy Δ∈ is 16 (the permittivity in a direction horizontal with respect to the director of the liquid crystal molecules included in the liquid crystal layer 15 being 19.8), and the birefringence An is 0.12. The thickness of the liquid crystal layer 15 is 3.21 μm. The permittivity of the insulating layer 11a is 3.2, and the thickness thereof is 0.35 μm. The permittivity of the insulating layer 11b is 3.2, and the thickness thereof is 1.53 μm. The electrode width L1 of the comb-shaped electrode 8a and the comb-shaped electrode 8b is 2.6 μm. The electrode gap width S1 between the comb-shaped electrode 8a and the comb-shaped electrode 8b is 3.5 μm.

### Working Example 2

In Working Example 2, the applied voltage (i) of the common electrode 7 is −0.8V/0.8V (corresponding to instances in which V_{cs}=0.8V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Working Example 2 is identical to that of Working Example 1, except for the applied voltage (i) of the common electrode 7. An explanation thereof will therefore not be repeated here.

### Working Example 3

In Working Example 3, the applied voltage (i) of the common electrode 7 is −1.2V/1.2V (corresponding to instances in which Vcs=1.2V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Working Example 3 is identical to that of Working Example 1, except for the applied voltage (i) of the common electrode 7. An explanation thereof will therefore not be repeated here.

### Working Example 4

In Working Example 4, the applied voltage (i) of the common electrode 7 is −1.3V/1.3V (corresponding to instances in which V_{cs}=1.3V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Working Example 4 is identical to that of Working Example 1, except for the applied voltage (i) of the common electrode 7. An explanation thereof will therefore not be repeated here.

### Working Example 5

In Working Example 5, the applied voltage (i) of the common electrode 7 is −1.6V/1.6V (corresponding to instances in which V_{cs}=1.6V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Working Example 5 is identical to that of Working Example 1, except for the applied voltage (i) of the common electrode 7. An explanation thereof will therefore not be repeated here.

### Working Example 6

In Working Example 6, the applied voltage (i) of the common electrode 7 is −2.0V/2.0V (corresponding to instances in which V_{cs}=2.0V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Working Example 6 is identical to that of Working Example 1, except for the applied voltage (i) of the common electrode 7. An explanation thereof will therefore not be repeated here.

### Working Example 7

In Working Example 7, the applied voltage (i) of the common electrode 7 is −2.4V/2.4V (corresponding to instances in which V_{cs}=2.4V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Working Example 7 is identical to that of Working Example 1, except for the applied voltage (i) of the common electrode 7. An explanation thereof will therefore not be repeated here.

<Comparative Configuration 1>

Comparative Configuration 1 has the same structure as the liquid crystal display device 1a according to Embodiment 1, and is configured such that, during black display and white display, the applied voltage (i) of the common electrode 7 is different from that of Embodiment 1. The liquid crystal display device according to Comparative Configuration 1 is identical to that of Embodiment 1, except for the applied voltage (i) of the common electrode 7. An explanation thereof will therefore not be repeated here.

Hereafter, an explanation will be given of comparative examples in which the liquid crystal display device according to Comparative Configuration 1 was actually manufactured.

### Comparative Example 1

In Comparative Example 1, the applied voltage (i) of the common electrode 7 is set to 0V (corresponding to instances in which V_{cs}=0V), and the common electrode 7 is not AC driven during black display and white display. The liquid crystal display device according to Comparative Example 1 is identical to that of Working Example 1, except for the applied voltage (i) of the common electrode 7. An explanation thereof will therefore not be repeated here.

### Comparative Example 2

In Comparative Example 2, the applied voltage (i) of the common electrode 7 is −2.5V/2.5V (corresponding to instances in which V_{cs}=2.5V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Comparative Example 2 is identical to that of Working Example 1, except for the applied voltage (i) of the common electrode 7. An explanation thereof will therefore not be repeated here.

### Comparative Example 3

In Comparative Example 3, the applied voltage (i) of the common electrode 7 is −2.56V/2.56V (corresponding to instances in which V_{cs}=2.56V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Comparative Example 3 is identical to that of Working Example 1, except for the applied voltage (i) of the common electrode 7. An explanation thereof will therefore not be repeated here.

### Comparative Example 4

In Comparative Example 4, the applied voltage (i) of the common electrode 7 is −2.562V/2.562V (corresponding to instances in which V_{cs}=2.562V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Comparative Example 4 is identical to that of Working Example 1, except for the applied voltage (i) of the common electrode 7. An explanation thereof will therefore not be repeated here.

### Comparative Example 5

In Comparative Example 5, the applied voltage (i) of the common electrode 7 is −2.563V/2.563V (corresponding to instances in which V_{cs}=2.563V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Comparative Example 5 is identical to that of Working Example 1, except for the applied voltage (i) of the common electrode 7. An explanation thereof will therefore not be repeated here.

### Comparative Example 6

In Comparative Example 6, the applied voltage (i) of the common electrode 7 is −2.8V/2.8V (corresponding to instances in which V_{cs}=2.8V). During black display and white display, a voltage having a polarity opposite to the applied voltage (iv) 7.5V/−7.5V of the opposite electrode 9 is applied to the common electrode 7, and the common electrode 7 is then AC driven. The liquid crystal display device according to Comparative Example 6 is identical to that of Working Example 1, except for the applied voltage (i) of the common electrode 7. An explanation thereof will therefore not be repeated here.

<Comparative Configuration 2>

Comparative Configuration 2 is a configuration in which the liquid crystal display device of Embodiment 1 does not include a common electrode. A liquid crystal display device of Comparative Configuration 2 is identical to the liquid crystal display device 101 shown in FIG. 18. An explanation thereof will therefore not be repeated here.

Hereafter, an explanation will be given of a comparative example in which the liquid crystal display device according to Comparative Configuration 2 was actually manufactured.

### Comparative Example 7

Comparative Example 7 has a configuration in which a liquid crystal display device according to Working Example 1 does not include a common electrode. The liquid crystal display device according to Comparative Example 7 is identical to that of Working Example 1, except that there is no common electrode. An explanation thereof will therefore not be repeated here.

<Evaluation Results: Contrast and Normalized Luminance During Black Display>

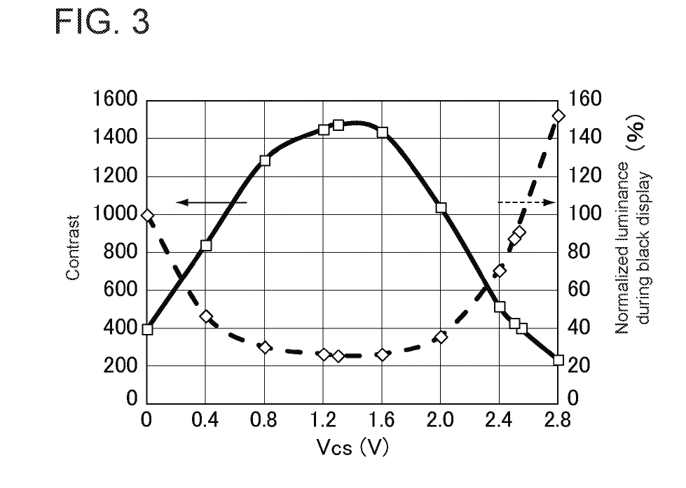

Values of V_{cs} (except for Comparative Example 7), contrast, and normalized luminance during black display for the liquid crystal display devices according to Working Examples 1 to 7 and Comparative Examples 1, 2, 3, 6, and 7 are shown in Table 1. In addition, FIG. 3 displays the contents of Table 1 (excluding Comparative Example 7) in graph form. FIG. 3 is graph that shows the contrast and normalized luminance during black display for the liquid crystal display devices according to Working Examples 1 to 7, and Comparative Examples 1, 2, 3, and 6. In FIG. 3, the horizontal axis represents values of V_{cs}, the left vertical axis represents contrast, and the right vertical axis represents normalized luminance during black display. In FIG. 3, the solid line represents the contrast and the dashed-line represents normalized luminance during black display. Normalized luminance during black display refers to the ratio of the various luminances during black display to the luminance during black display when V_{cs} is 0V (which corresponds to Comparative Example 1).

(Method of Measuring Contrast and Luminance)

The contrast was measured using the following expression: (contrast)=(luminance during white display)/(luminance during black display). A luminance colorimeter (BM-5A) manufactured by Topcon Corp. was used to measure the luminance (the luminance during both white display and black display).

TABLE 1

| | | | Normalized |
|---|---|---|---|
| | | | Luminance During |
| | V_{cs} (V) | Contrast | Black Display (%) |
| Comparative Example 1 | 0 | 398 | 100 |
| Working Example 1 | 0.4 | 842 | 47 |
| Working Example 2 | 0.8 | 1289 | 30 |
| Working Example 3 | 1.2 | 1452 | 27 |
| Working Example 4 | 1.3 | 1476 | 26 |
| Working Example 5 | 1.6 | 1437 | 26 |
| Working Example 6 | 2.0 | 1041 | 36 |
| Working Example 7 | 2.4 | 518 | 71 |
| Comparative Example 2 | 2.5 | 431 | 87 |
| Comparative Example 3 | 2.56 | 400 | 91 |
| Comparative Example 6 | 2.8 | 235 | 152 |
| Comparative Example 7 | — | 69 | 577 |

The evaluation results for the contrast and normalized luminance during black display for the various examples will be explained below.

### Working Example 1

The contrast was 842, and the normalized luminance during black display was 47%. These results show that luminance during black display was lower than in Comparative Example 1, which resulted in the contrast being higher. Thus, according to the configuration of Working Example 1, it is possible to sufficiently improve the contrast in an ON-ON switching mode liquid crystal display device.

### Working Example 2

The contrast was 1289, and the normalized luminance during black display was 30%. These results show that the luminance during black display was lower than in Comparative Example 1, which resulted in the contrast being higher. Thus, according to the configuration of Working Example 2, it is possible to sufficiently improve the contrast in an ON-ON switching mode liquid crystal display device.

### Working Example 3

The contrast was 1452, and the normalized luminance during black display was 27%.

These results show that the luminance during black display was lower than in Comparative Example 1, which resulted in the contrast being higher. Thus, according to the configuration of Working Example 3, it is possible to sufficiently improve the contrast in an ON-ON switching mode liquid crystal display device.

### Working Example 4

The contrast was 1476, and the normalized luminance during black display was 26%. These results show that the luminance during black display was lower than in Comparative Example 1, which resulted in the contrast being higher. In addition, compared to the other working examples, Working Example 4 had the highest contrast. Thus, according to the configuration of Working Example 4, it is possible to sufficiently improve the contrast in an ON-ON switching mode liquid crystal display device.

### Working Example 5

The contrast was 1437, and the normalized luminance during black display was 26%. These results show that the luminance during black display was lower than in Comparative Example 1, which resulted in the contrast being higher. Thus, according to the configuration of Working Example 5, it is possible to sufficiently improve the contrast in an ON-ON switching mode liquid crystal display device.

### Working Example 6

The contrast was 1041, and the normalized luminance during black display was 36%. These results show that the luminance during black display was lower than in Comparative Example 1, which resulted in the contrast being higher. Thus, according to the configuration of Working Example 6, it is possible to sufficiently improve the contrast in an ON-ON switching mode liquid crystal display device.

### Working Example 7

The contrast was 518, and the normalized luminance during black display was 71%. These results show that the luminance during black display was lower than in Comparative Example 1, which resulted in the contrast being higher. Thus, according to the configuration of Working Example 7, it is possible to sufficiently improve the contrast in an ON-ON switching mode liquid crystal display device.

### Comparative Example 1

The contrast was 398, and the normalized luminance during black display was 100%. These results indicate that the difference in voltage between the various electrodes during black display has not been optimized, and that it is not possible to sufficiently prevent light leakage during black display; thus, there will be a drop in the contrast. Therefore, using the configuration of Comparative Example 1, it is not possible to sufficiently improve the contrast in an ON-ON switching mode liquid crystal display device.

### Comparative Example 2

The contrast was 431, and the normalized luminance during black display was 87%. These results show that the contrast was higher than in Comparative Example 1. Taking into consideration, however, variations in the physical properties of the members constituting the liquid crystal display devices, variations (such as variations in the thickness of the liquid crystal layer) that occurred during the manufacturing process of the liquid crystal display device, and the like, it can be said that there is actually no significant difference between the contrast of Comparative Example 1 and the contrast of Comparative Example 2. Therefore, using the configuration of Comparative Example 2, it is not possible to sufficiently improve the contrast in an ON-ON switching mode liquid crystal display device.

### Comparative Example 3

The contrast was 400, and the normalized luminance during black display was 91%. These results show that the contrast was higher than in Comparative Example 1. Taking into consideration, however, variations in the physical properties of the members constituting the liquid crystal display device, variations (such as variations in the thickness of the liquid crystal layer) that occurred during the manufacturing process of the liquid crystal display device, and the like, it can be said that there is actually no significant difference between the contrast of Comparative Example 1 and the contrast of Comparative Example 3. Therefore, using the configuration of Comparative Example 3, it is not possible to sufficiently improve the contrast in an ON-ON switching mode liquid crystal display device.

### Comparative Example 6

The contrast was 235, and the normalized luminance during black display was 152%. These results show that the luminance during black display was higher than in Comparative Example 1, which resulted in the contrast being lower. In other words, these results indicate that the difference in voltage between the various electrodes during black display has not been optimized, and that it is not possible to sufficiently prevent light leakage during black display; thus, there will be a drop in contrast. Therefore, using the configuration of Comparative Example 6, it is not possible to sufficiently improve the contrast in an ON-ON switching mode liquid crystal display device.

### Comparative Example 7

The contrast was 69, and the normalized luminance during black display was 577%. These results show that the luminance during black display was much higher than in Comparative Example 1, which resulted in the contrast being much lower. In other words, these results show that since there is no electrode corresponding to the common electrode for adjusting differences in voltage with the pair of comb-shaped electrodes, it is not possible to prevent the generation of an oblique electric field during black display. Thus, the liquid crystal molecules located near the edges of the pair of comb-shaped electrodes rotate, resulting in a much larger amount of light leakage during black display and a significant decrease in contrast compared to an ON-ON switching mode liquid crystal display device. Therefore, it is not possible to sufficiently improve the contrast using the configuration of Comparative Example 7.

<Evaluation Results: Director Distribution, Transmittance Distribution, and Electric Field Distribution During Black Display>

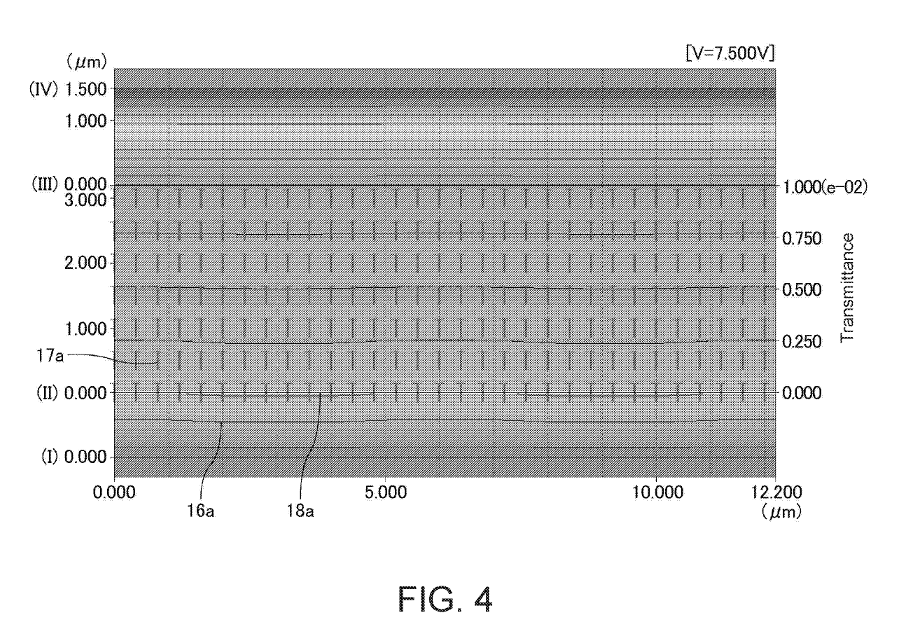

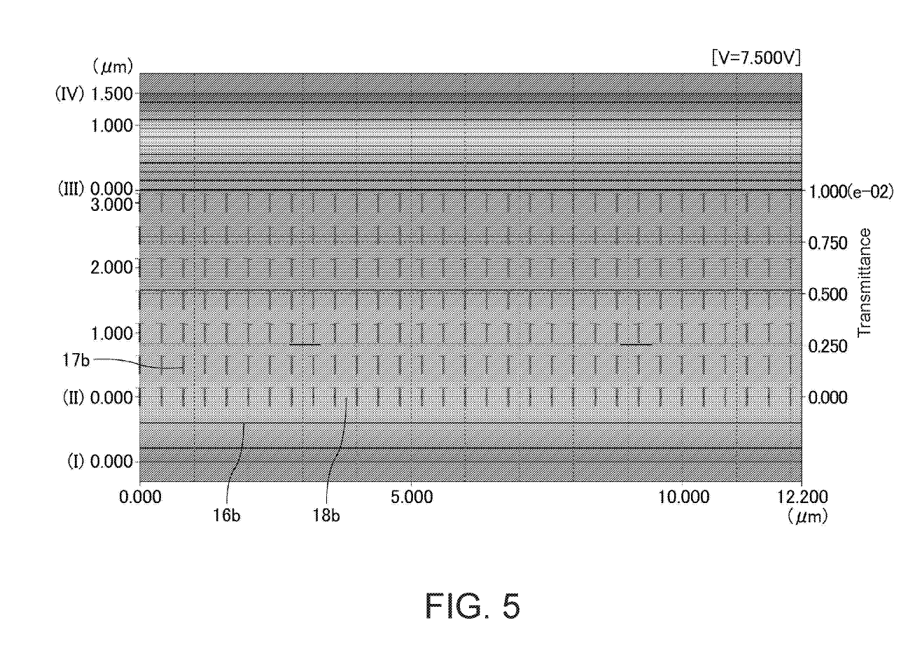

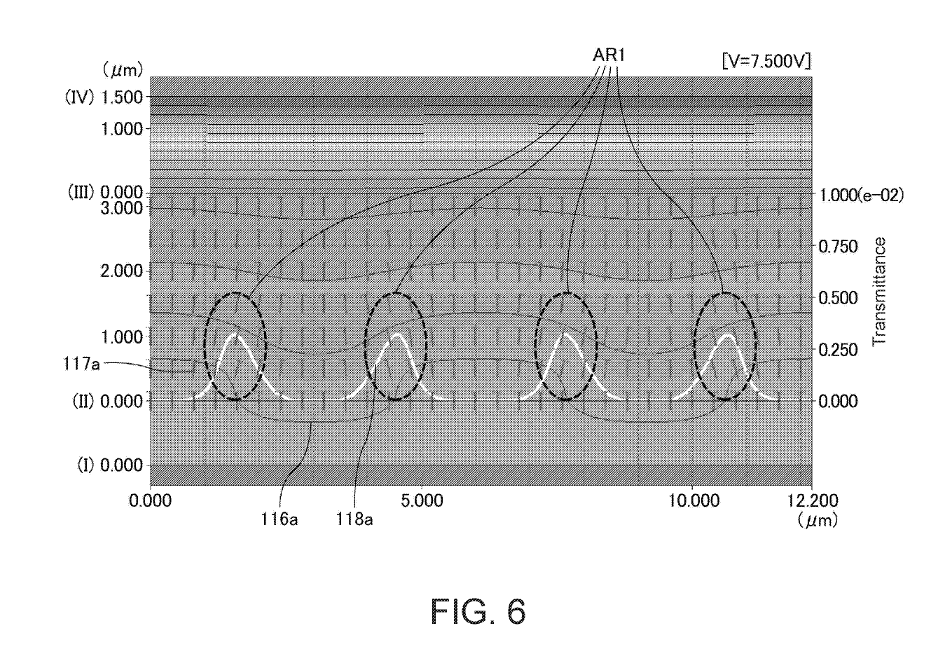

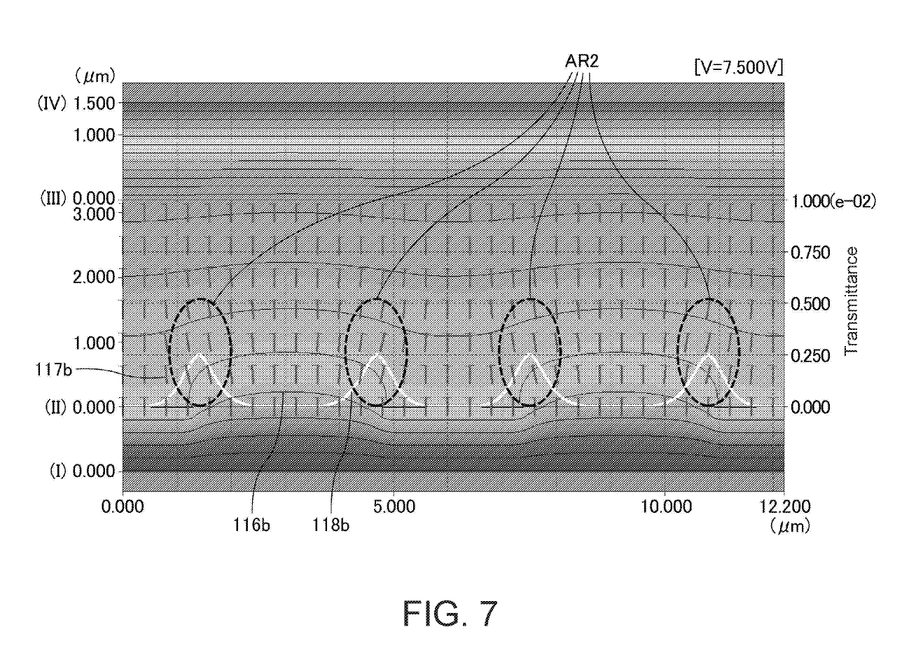

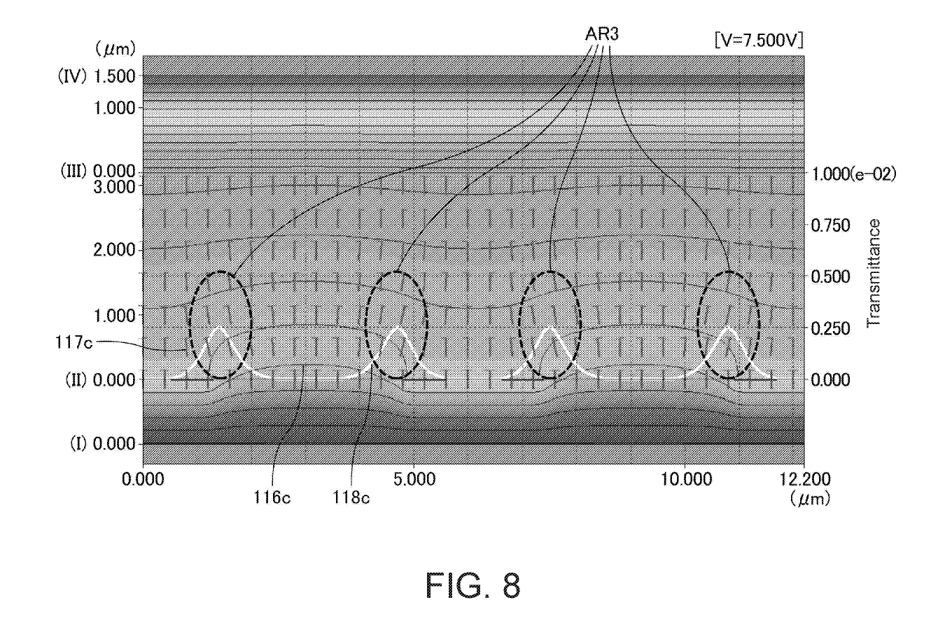

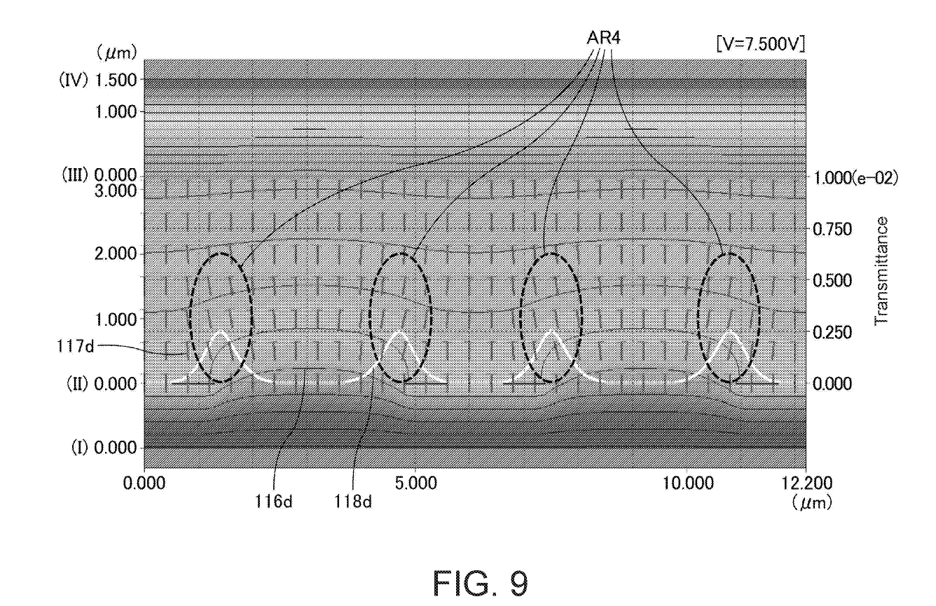

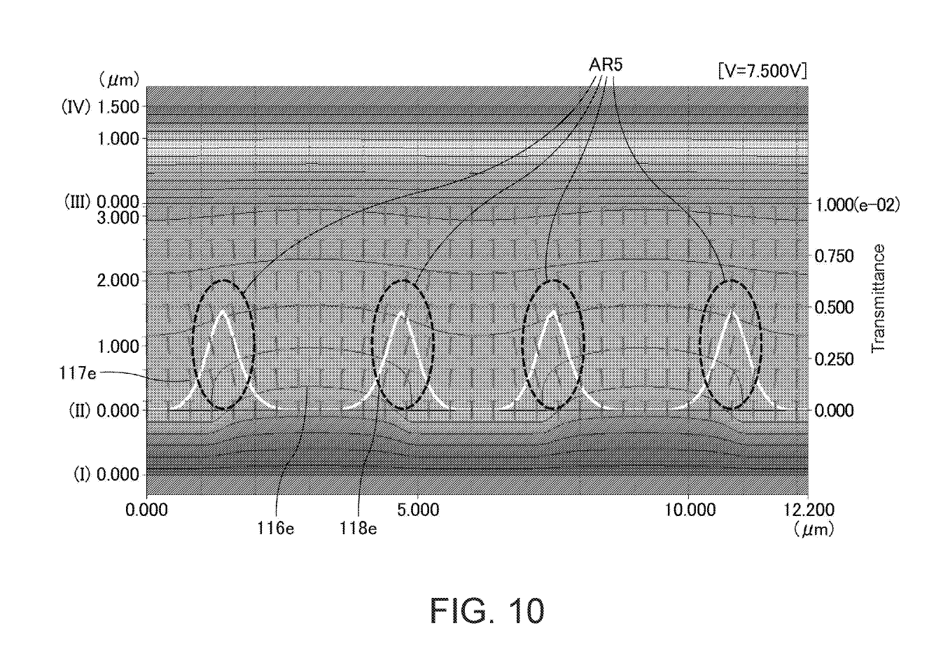

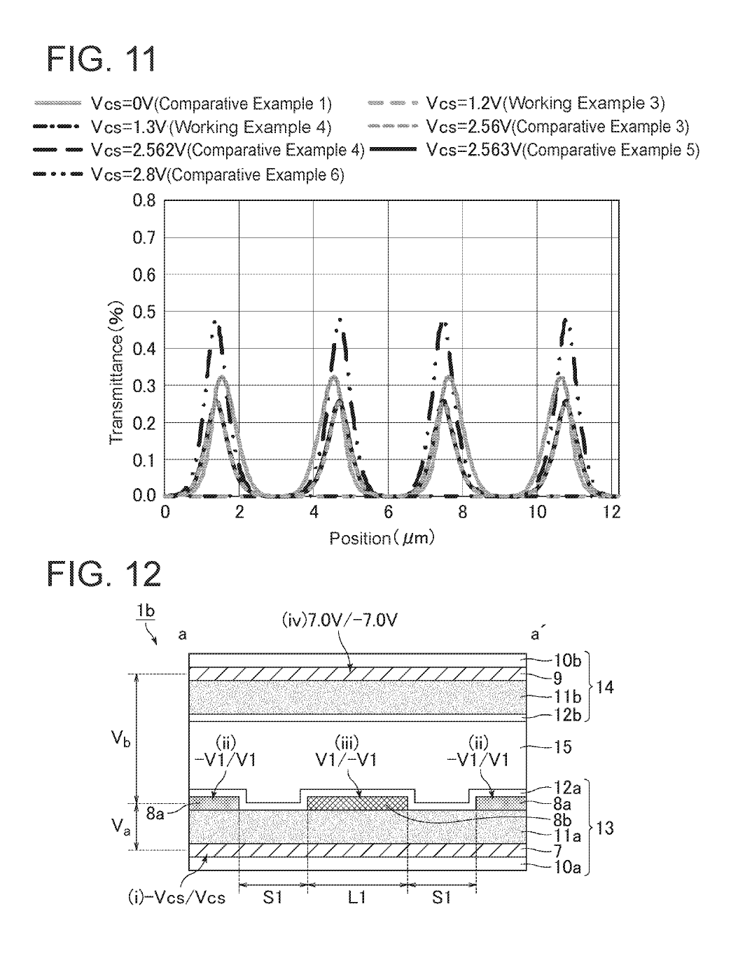

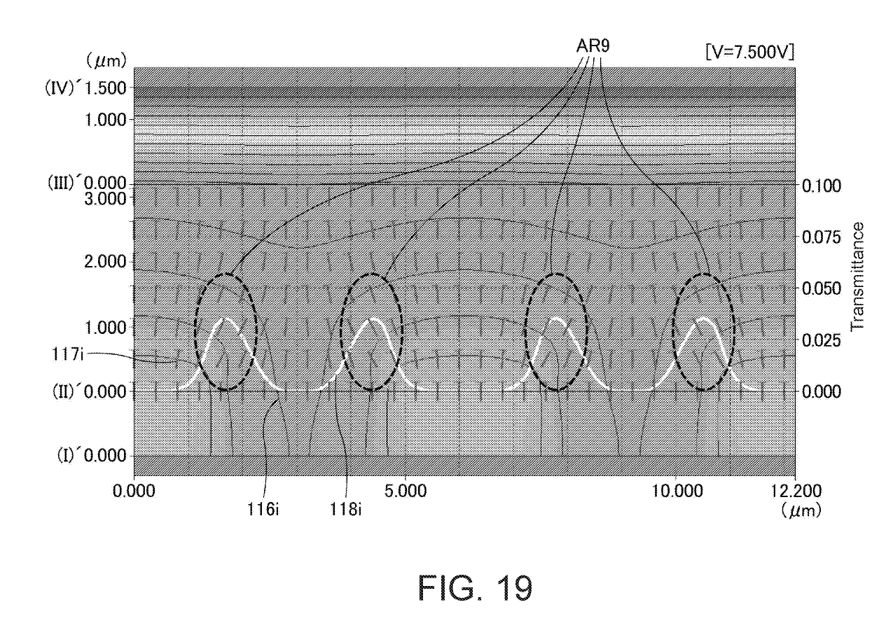

FIGS. 4 to 10 show the simulation results for the director distribution, transmittance distribution, and electric field distribution (equipotential surface) during black display for the liquid crystal display devices of Working Examples 3 and 4, and Comparative Examples 1, 3, 4, 5, and 6. FIG. 4 shows the director distribution, the transmittance distribution, and the electric field distribution during black display for the liquid crystal display device according to Working Example 3. FIG. 5 shows the director distribution, the transmittance distribution, and the electric field distribution during black display for the liquid crystal display device according to Working Example 4. FIG. 6 shows the director distribution, the transmittance distribution, and the electric field distribution during black display for the liquid crystal display device according to Comparative Example 1. FIG. 7 shows the director distribution, the transmittance distribution, and the electric field distribution during black display for the liquid crystal display device according to Comparative Example 3. FIG. 8 shows the director distribution, the transmittance distribution, and the electric field distribution during black display for the liquid crystal display device according to Comparative Example 4. FIG. 9 shows the director distribution, the transmittance distribution, and the electric field distribution during black display for the liquid crystal display device according to Comparative Example 5. FIG. 10 shows the director distribution, the transmittance distribution, and the electric field distribution during black display for the liquid crystal display device according to Comparative Example 6. FIGS. 4 to 10 were created using an LCD Master manufactured by Shintech Inc. The director distribution, the transmittance distribution, and the electric field distribution during black display for the liquid crystal display device according to Comparative Example 7 are the same as the results shown in FIG. 19. An explanation thereof will therefore not be repeated here. FIG. 11 is a graph that superimposes the transmittance distributions from FIGS. 4 to 10 on one another. FIG. 11 shows the transmittance distribution during black display for the liquid crystal display devices according to Working Examples 3 and 4, and Comparative Examples 1, 3, 4, 5, and 6.

The correspondence between the values shown on the horizontal axis, left vertical axis, and right vertical axis in FIGS. 4 to 10 and the locations of respective members shown in FIG. 2 will be explained below. Looking at the horizontal axis in FIGS. 4 to 10, the values 0.000 m to 1.300 m represent a region where the left-hand portion of the comb-shaped electrode 8a exists, the values 1.300 m to 4.800 m represent a region between the left-hand portion of the comb-shaped electrode 8a and the comb-shaped electrode 8b, the values 4.800 m to 7.400 m represent a region where the comb-shaped electrode 8b exists, the values 7.400 m to 10.900 m represent a region between the comb-shaped electrode 8b and the right-hand portion of the comb-shaped electrode 8a, and the values 10.900 m to 12.200 m represent a region where the right-hand portion of the comb-shaped electrode 8a exists. Looking at the left vertical axis in FIGS. 4 to 10, (I) 0.000 m is the location of the interface of the common electrode 7 and the insulating layer 11a, (II) 0.000 m is the location of the interface of the insulating layer 11a and the liquid crystal layer 15 (the interface of the insulating layer 11a and the pair of comb-shaped electrodes 8a, 8b), (III) 0.000 m is the location of the interface of the liquid crystal layer 15 and the insulating layer 11b, and (IV) 1.500 m is the location of the interface of the insulating layer 11b and the opposite electrode 9. At (II) 0.000 m and (III) 0.000 m, the thickness of the horizontal alignment films 12a, 12b is negligible; thus, these two locations are substantially the location of the interface of the insulating layer 11a and the liquid crystal layer 15 (the interface of the insulating layer 11a and the pair of comb-shaped electrodes 8a, 8b) and the location of the interface of the liquid crystal layer 15 and the insulating layer 11b, respectively. The right vertical axis in FIGS. 4 to 10 represents transmittance. The director distribution, the transmittance distribution, and the electric field distribution (equipotential surface) during black display were simulated over a region corresponding to the values 0.000 μm to 12.200 μm on the horizontal axis in FIGS. 4 to 10 for the liquid crystal display devices of Working Examples 3 and 4, and Comparative Examples 1, 3, 4, 5, and 6.

Evaluation results of the director distribution, transmittance distribution, and electric field distribution during black display for the various examples will be explained below.

### Working Example 3

FIG. 4 is a simulation of an electric field distribution (equipotential surface) 16a, a distribution of directors 17a, and a transmittance distribution 18a for a black display state in the liquid crystal display device 1a shown in FIG. 2 in which the applied voltage (i) of the common electrode 7 is set to −1.2V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 4).

As shown in FIG. 4, during black display, the equipotential surface between the comb-shaped electrode 8a and the comb-shaped electrode 8b is substantially the same height as the equipotential surface above the pair of comb-shaped electrodes 8a, 8b. In addition, in FIG. 4, the height of the equipotential surface between the comb-shaped electrode 8a and the comb-shaped electrode 8b is closer to the height of the equipotential surface above the pair of comb-shaped electrodes 8a, 8b than in FIG. 6 (Comparative Example 1), which will be explained later. Thus, the vertical electric field between the lower substrate 13 and the upper substrate 14 in Working Example 3 is applied more uniformly compared to Comparative Example 1. Therefore, as can be seen by looking at the directors 17a in FIG. 4, the liquid crystal molecules are more evenly vertically oriented; thus, it is possible to sufficiently prevent light leakage during black display. In addition, as can be seen from the transmittance distributions in FIG. 11, light leakage near the edges of the pair of comb-shaped electrodes 8a, 8b is sufficiently suppressed in Working Example 3 compared to Comparative Example 1.

### Working Example 4

FIG. 5 is a simulation of an electric field distribution (equipotential surface) 16b, a distribution of directors 17b, and a transmittance distribution 18b for a black display state in the liquid crystal display device 1a shown in FIG. 2 in which the applied voltage (i) of the common electrode 7 is set to −1.3V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 5).

As shown in FIG. 5, during black display, the equipotential surface between the comb-shaped electrode 8a and the comb-shaped electrode 8b is substantially the same height as the equipotential surface above the pair of comb-shaped electrodes 8a, 8b. In addition, in FIG. 5, the height of the equipotential surface between the comb-shaped electrode 8a and the comb-shaped electrode 8b is closer to the height of the equipotential surface above the pair of comb-shaped electrodes 8a, 8b than in FIG. 4 (Working Example 3). Thus, the vertical electric field between the lower substrate 13 and the upper substrate 14 in Working Example 4 is applied more uniformly compared to Working Example 3. Therefore, as can be seen by looking at the directors 17b in FIG. 5, the liquid crystal molecules are more evenly vertically oriented; thus, it is possible to sufficiently prevent light leakage during black display. In addition, as can be seen from the transmittance distributions in FIG. 11, light leakage near the edges of the pair of comb-shaped electrodes 8a, 8b is sufficiently suppressed in Working Example 4 compared to Comparative Example 1.

Furthermore, looking at the transmittance distributions during black display for Working Examples 1, 2, 5, 6, and 7, as shown in Table 1, the luminance is lower and the contrast is higher during black display compared to Comparative Example 1. Thus, it is clear that, similar to Working Examples 3 and 4, light leakage near the edges the pair of comb-shaped electrodes 8a, 8b has been sufficiently suppressed in the above-mentioned working examples compared to Comparative Example 1.

### Comparative Example 1

FIG. 6 is a simulation of an electric field distribution (equipotential surface) 116a, a distribution of directors 117a, and a transmittance distribution 118a for a black display state in the liquid crystal display device 1a shown in FIG. 2 in which the applied voltage (i) of the common electrode 7 is set to 0V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 6).

As shown in FIG. 6, during black display, the equipotential surface between the comb-shaped electrode 8a and the comb-shaped electrode 8b is located lower (recessed toward the insulating layer 11a) than the equipotential surface above the pair of comb-shaped electrodes 8a, 8b. Thus, the vertical electric field between the lower substrate 13 and the upper substrate 14 is not applied uniformly in Comparative Example 1. As a result, an oblique electric field component is generated, and as shown by regions AR1, the liquid crystal molecules near the edges of the pair of comb-shaped electrodes 8a, 8b rotate. Therefore, as can be seen from the transmittance distributions shown in FIG. 11, light leakage near the edges of the pair of comb-shaped electrodes 8a, 8b is not sufficiently suppressed in Comparative Example 1 compared to the various working examples.

### Comparative Example 3

FIG. 7 is a simulation of an electric field distribution (equipotential surface) 116b, a distribution of directors 117b, and a transmittance distribution 118b for a black display state of the liquid crystal display device 1a shown in FIG. 2 in which the applied voltage (i) of the common electrode 7 is set to −2.56V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 7).

As shown in FIG. 7, during black display, the equipotential surface between the comb-shaped electrode 8a and the comb-shaped electrode 8b is located higher (rising toward the liquid crystal layer 15) than the equipotential surface above the pair of comb-shaped electrodes 8a, 8b. Thus, the vertical electric field between the lower substrate 13 and the upper substrate 14 is not applied uniformly in Comparative Example 3. As a result, an oblique electric field component is generated, and as shown by regions AR2, the liquid crystal molecules located near the edges of the pair of comb-shaped electrodes 8a, 8b rotate. Therefore, as can be seen from the transmittance distributions shown in FIG. 11, light leakage near the edges of the pair of comb-shaped electrodes 8a, 8b is not sufficiently suppressed in Comparative Example 3 compared to the various working examples.

### Comparative Example 4

FIG. 8 is a simulation of an electric field distribution (equipotential surface) 116c, a distribution of directors 117c, and a transmittance distribution 118c for a black display state of the liquid crystal display device 1a shown in FIG. 2 in which the applied voltage (i) of the common electrode 7 is set to −2.562V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 8).

As shown in FIG. 8, during black display, the equipotential surface between the comb-shaped electrode 8a and the comb-shaped electrode 8b is located higher (rising toward the liquid crystal layer 15) than the equipotential surface above the pair of comb-shaped electrodes 8a, 8b. Thus, the vertical electric field between the lower substrate 13 and the upper substrate 14 is not applied uniformly in Comparative Example 4. As a result, an oblique electric field component is generated, and as shown by regions AR3, the liquid crystal molecules located near the edges of the pair of comb-shaped electrodes 8a, 8b rotate. Therefore, as can be seen from the transmittance distributions shown in FIG. 11, light leakage near the edges of the pair of comb-shaped electrodes 8a, 8b is not sufficiently suppressed in Comparative Example 4 compared to the various working examples.

### Comparative Example 5

FIG. 9 is a simulation of an electric field distribution (equipotential surface) 116d, a distribution of directors 117d, and a transmittance distribution 118d for a black display state of the liquid crystal display device 1a shown in FIG. 2 in which the applied voltage (i) of the common electrode 7 is set to −2.563V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 9).

As shown in FIG. 9, during black display, the equipotential surface between the comb-shaped electrode 8a and the comb-shaped electrode 8b is located higher (rising toward the liquid crystal layer 15) than the equipotential surface above the pair of comb-shaped electrodes 8a, 8b. Thus, the vertical electric field between the lower substrate 13 and the upper substrate 14 is not applied uniformly in Comparative Example 5. As a result, an oblique electric field component is generated, and as shown by regions AR4, the liquid crystal molecules located near the edges of the pair of comb-shaped electrodes 8a, 8b rotate. Therefore, as can be seen from the transmittance distributions shown in FIG. 11, light leakage near the edges of the pair of comb-shaped electrodes 8a, 8b is not sufficiently suppressed in Comparative Example 5 compared to the various working examples.

### Comparative Example 6

FIG. 10 is a simulation of an electric field distribution (equipotential surface) 116e, a distribution of directors 117e, and a transmittance distribution 118e for a black display state of the liquid crystal display device 1a shown in FIG. 2 in which the applied voltage (i) of the common electrode 7 is set to −2.8V, the applied voltages (ii), (iii) of the pair of comb-shaped electrodes 8a, 8b are respectively set to 0V (black display), and the applied voltage (iv) of the opposite electrode 9 is set to 7.5V (which corresponds to V=7.500V in FIG. 10).

As shown in FIG. 10, during black display, the equipotential surface between the comb-shaped electrode 8a and the comb-shaped electrode 8b is located higher (rising toward the liquid crystal layer 15) than the equipotential surface above the pair of comb-shaped electrodes 8a, 8b. Thus, the vertical electric field between the lower substrate 13 and the upper substrate 14 is not applied uniformly in Comparative Example 6. As a result, an oblique electric field component is generated, and as shown by regions AR5, the liquid crystal molecules located near the edges of the pair of comb-shaped electrodes 8a, 8b rotate. Therefore, as can be seen from the transmittance distributions shown in FIG. 11, light leakage near the edges of the pair of comb-shaped electrodes 8a, 8b is not sufficiently suppressed in Comparative Example 6 compared to the various working examples.

### Comparative Example 7

The director distribution, transmittance distribution, and electric field distribution during black display for the liquid crystal display device according to Comparative Example 7 are the same as the results shown in FIG. 19. An explanation thereof will therefore not be repeated here.

In FIG. 19, the equipotential surface between the comb-shaped electrode 108a and the comb-shaped electrode 108b is located lower than the equipotential surface between the comb-shaped electrode 8a and the comb-shaped electrode 8b in FIG. 6 (Comparative Example 1). Thus, the vertical electric field between the lower substrate 113 and the upper substrate 114 is applied less uniformly than the vertical electric field between the lower substrate 13 and the upper substrate 14 in Comparative Example 1. As a result, a larger oblique electric field component is generated, and as shown by regions AR9, the liquid crystal molecules located near the edges of the pair of comb-shaped electrodes 108a, 108b rotate to a larger extent. Therefore, as can be seen from the transmittance distribution 118i in FIG. 19, light leakage near the edges of the pair of comb-shaped electrodes 108a, 108b is not sufficiently suppressed compared to not only the various working examples, but also compared to the various comparative examples.

### Embodiment 2

Embodiment 2 is a liquid crystal display device that, in the first liquid crystal liquid crystal display device of the present invention, a voltage of 7.0 V is applied to the second planar electrode during black display and white display and the second planar electrode is then AC driven.

FIG. 1 is a schematic plan view of one pixel of the liquid crystal display device according to Embodiment 2. FIG. 12 is schematic cross-sectional view of the liquid crystal display device according to Embodiment 2 that shows a cross-section that corresponds to the line segment a-a′ in FIG. 1. As shown in FIG. 12, a liquid crystal display device 1b according to Embodiment 2 is identical to the liquid crystal display device 1a according to Embodiment 1, except for the applied voltage (iv) of the opposite electrode 9. An explanation thereof will therefore not be repeated.

In FIG. 12, the applied voltage (iv) 7.0V/−7.0V of the opposite electrode 9 indicates that, during black display and white display, a voltage of 7.0V is applied to the opposite electrode 9 and the opposite electrode 9 is AC driven in phase with the comb-shaped electrode 8b.

In FIG. 12, Vₐ represents a difference in voltage between the voltage of the common electrode 7 and the voltage of the pair of comb-shaped electrodes 8a, 8b in the liquid crystal display device 1b according to Embodiment 2. For this difference in voltage, the voltage of the common electrode 7 is used as the reference value, and the direction of the arrows represents the positive direction. V_{b} represents a difference in voltage between the voltage of the pair of comb-shaped electrodes 8a, 8b and the voltage of the opposite electrode 9 in the liquid crystal display device 1b according to Embodiment 2. For this difference in voltage, the voltage of the pair of comb-shaped electrodes 8a, 8b is used as the reference value, and the direction of the arrows represents the positive direction. The relationship and the like of Vₐ and V_{b} will be explained later.

In addition, Vₐ and V_{b} shown in FIG. 12 respectively correspond to Vₐ and V_{b} of the first liquid crystal display device of the present invention.

Hereafter, an explanation will be given of working examples in which the liquid crystal display device according to Embodiment 2 was actually manufactured.

### Working Example 8

In Working Example 8, the applied voltage (i) of the common electrode 7 is −0.4V/0.4V (corresponding to instances in which V_{cs}=0.4V). During black display and white display, a voltage having a polarity opposite to the applied voltage (iv) 7.0V/−7.0V of the opposite electrode 9 is applied to the common electrode 7, and the common electrode 7 is then AC driven. As shown above, for the applied voltages (ii), (iii) of the pair of comb-shaped electrodes 8a, 8b, V1 is set to 0V during black display and 6V during white display.

In Working Example 8, the liquid crystal molecules included in the liquid crystal layer 15 have a positive dielectric anisotropy. The dielectric anisotropy Δ∈ is 16, and the birefringence An is 0.12. The thickness of the liquid crystal layer 15 is 3.21 μm. The permittivity of the insulating layer 11a is 3.2, and the thickness thereof is 0.35 μm. The permittivity of the insulating layer 11b is 3.2, and the thickness thereof is 1.53 μm. The electrode width L1 of the comb-shaped electrode 8a and the comb-shaped electrode 8b is 2.6 μm. The electrode gap width S1 between the comb-shaped electrode 8a and the comb-shaped electrode 8b is 3.5 μm.

### Working Example 9

In Working Example 9, the applied voltage (i) of the common electrode 7 is −0.8V/0.8V (corresponding to instances in which V_{cs}=0.8V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Working Example 9 is identical to that of Working Example 8, except for the applied voltage (i) of the common electrode 7. An explanation thereof will therefore not be repeated here.

### Working Example 10

In Working Example 10, the applied voltage (i) of the common electrode 7 is −1.2V/1.2V (corresponding to instances in which V_{cs}=1.2V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Working Example 10 is identical to that of Working Example 8, except for the applied voltage (i) of the common electrode 7. An explanation thereof will therefore not be repeated here.

### Working Example 11

In Working Example 11, the applied voltage (i) of the common electrode 7 is −1.6V/1.6V (corresponding to instances in which V_{cs}=1.6V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Working Example 11 is identical to that of Working Example 8, except for the applied voltage (i) of the common electrode 7. An explanation thereof will therefore not be repeated here.

### Working Example 12

In Working Example 12, the applied voltage (i) of the common electrode 7 is −2.0V/2.0V (corresponding to instances in which V_{cs}=2.0V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Working Example 12 is identical to that of Working Example 8, except for the applied voltage (i) of the common electrode 7. An explanation thereof will therefore not be repeated here.

<Comparative Configuration 3>

Comparative Configuration 3 has the same structure as the liquid crystal display device 1b according to Embodiment 2, and is configured such that, during black display and white display, the applied voltage (i) of the common electrode 7 is different from that of Embodiment 2. The liquid crystal display device according to Comparative Configuration 3 is identical to that of Embodiment 2, except for the applied voltage (i) of the common electrode 7. An explanation thereof will therefore not be repeated here.

Hereafter, an explanation will be given of comparative examples in which the liquid crystal display device according to Comparative Configuration 3 was actually manufactured.

### Comparative Example 8

In Comparative Example 8, the applied voltage (i) of the common electrode 7 is set to 0V (corresponding to instances in which V_{cs}=0V), and the common electrode 7 is not AC driven during black display and white display. The liquid crystal display device according to Comparative Example 8 is identical to that of Working Example 8, except for the applied voltage (i) of the common electrode 7. An explanation thereof will therefore not be repeated here.

### Comparative Example 9

In Comparative Example 9, the applied voltage (i) of the common electrode 7 is −2.39V/2.39V (corresponding to instances in which V_{cs}=2.39V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Comparative Example 9 is identical to that of Working Example 8, except for the applied voltage (i) of the common electrode 7. An explanation thereof will therefore not be repeated here.

### Comparative Example 10

In Comparative Example 10, the applied voltage (i) of the common electrode 7 is −2.392V/2.392V (corresponding to instances in which V_{cs}=2.392V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Comparative Example 10 is identical to that of Working Example 8, except for the applied voltage (i) of the common electrode 7. An explanation thereof will therefore not be repeated here.

### Comparative Example 11

In Comparative Example 11, the applied voltage (i) of the common electrode 7 is −2.4V/2.4V (corresponding to instances in which V_{cs}=2.4V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Comparative Example 11 is identical to that of Working Example 8, except for the applied voltage (i) of the common electrode 7. An explanation thereof will therefore not be repeated here.

### Comparative Example 12

In Comparative Example 12, the applied voltage (i) of the common electrode 7 is −2.8V/2.8V (corresponding to instances in which V_{cs}=2.8V). During black display and white display, a voltage having a polarity opposite to the applied voltage (iv) 7.0V/−7.0V of the opposite electrode 9 is applied to the common electrode 7, and the common electrode 7 is then AC driven. The liquid crystal display device according to Comparative Example 12 is identical to that of Working Example 8, except for the applied voltage (i) of the common electrode 7. An explanation thereof will therefore not be repeated here.

<Evaluation Results: Contrast and Normalized Luminance During Black Display>

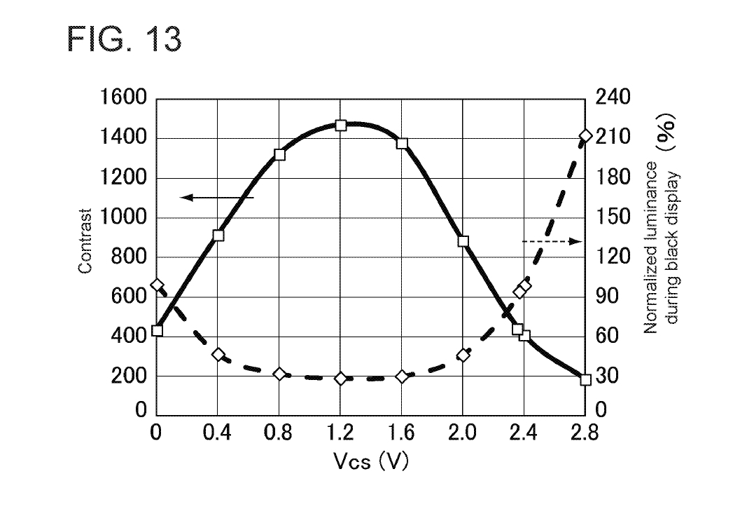

Values of V_{cs}, contrast, and normalized luminance during black display for the liquid crystal display devices according to Working Examples 8 to 12 and Comparative Examples 8, 9, 11, and 12 are shown in Table 2. FIG. 13 displays the contents of Table 2 in graph form. FIG. 13 is a graph that shows contrast and normalized luminance during black display for the liquid crystal display devices according to Embodiments 8 to 12, and Comparative Examples 8, 9, 11, and 12. In FIG. 13, the horizontal axis represents values of V_{cs}, the left vertical axis represents contrast, and the right vertical axis represents normalized luminance during black display. In FIG. 13, the solid line shows contrast and the dashed-line shows normalized luminance during black display. Normalized luminance during black display refers to the ratio of the various luminances during black display to the luminance during black display when V_{cs} is 0V (which corresponds to Comparative Example 8).

(Method of Measuring Contrast and Luminance)

The contrast was measured using the following expression: (contrast)=(luminance during white display)/(luminance during black display). A luminance colorimeter (BM-5A) manufactured by Topcon Corp. was used to measure the luminance (the luminance during both white display and black display).

TABLE 2

| | | | Normalized |
|---|---|---|---|
| | | | Luminance During |
| | V_{cs} (V) | Contrast | Black Display (%) |
| Comparative Example 8 | 0 | 436 | 100 |
| Working Example 8 | 0.4 | 917 | 47 |
| Working Example 9 | 0.8 | 1324 | 32 |
| Working Example 10 | 1.2 | 1471 | 29 |
| Working Example 11 | 1.6 | 1380 | 30 |
| Working Example 12 | 2.0 | 886 | 47 |
| Comparative Example 9 | 2.39 | 439 | 93 |
| Comparative Example 11 | 2.4 | 410 | 99 |
| Comparative Example 12 | 2.8 | 187 | 213 |

The evaluation results for the contrast and normalized luminance during black display for the various examples will be explained below.

### Working Example 8

The contrast was 917, and the normalized luminance during black display was 47%. These results show that the luminance during black display was lower than in Comparative Example 8, which resulted in the contrast being higher. Thus, according to the configuration of Working Example 8, it is possible to sufficiently improve the contrast in an ON-ON switching mode liquid crystal display device.

### Working Example 9

The contrast was 1324, and the normalized luminance during black display was 32%. These results show that the luminance during black display was lower than in Comparative Example 8, which resulted in the contrast being higher. Thus, according to the configuration of Working Example 9, it is possible to sufficiently improve the contrast in an ON-ON switching mode liquid crystal display device.

### Working Example 10

The contrast was 1471, and the normalized luminance during black display was 29%. These results show that the luminance during black display was lower than in Comparative Example 8, which resulted in the contrast being higher. In addition, compared to the other working examples, Working Example 10 had the highest contrast. Thus, according to the configuration of Working Example 10, it is possible to sufficiently improve the contrast in an ON-ON switching mode liquid crystal display device.

### Working Example 11

The contrast was 1380, and the normalized luminance during black display was 30%. These results show that the luminance during black display was lower than in Comparative Example 8, which resulted in the contrast being higher. Thus, according to the configuration of Working Example 11, it is possible to sufficiently improve the contrast in an ON-ON switching mode liquid crystal display device.

### Working Example 12

The contrast was 886, and the normalized luminance during black display was 47%. These results show that the luminance during black display was lower than in Comparative Example 8, which resulted in the contrast being higher. Thus, according to the configuration of Working Example 12, it is possible to sufficiently improve the contrast in an ON-ON switching mode liquid crystal display device.

### Comparative Example 8

The contrast was 436, and the normalized luminance during black display was 100%. These results indicate that the difference in voltage between the various electrodes during black display has not been optimized, and that it is not possible to sufficiently prevent light leakage during black display; thus, there will be a drop in the contrast. Therefore, using the configuration of Comparative Example 8, it is not possible to sufficiently improve the contrast in an ON-ON switching mode liquid crystal display device.

### Comparative Example 9

The contrast was 439, and the normalized luminance during black display was 93%. These results show that the contrast was higher than in Comparative Example 8. Taking into consideration, however, variations in the physical properties of the members constituting the liquid crystal display device, variations (such as variations in the thickness of the liquid crystal layer) that occurred during the manufacturing process of the liquid crystal display device, and the like, it can be said that there is actually no significant difference between the contrast of Comparative Example 9 and the contrast of Comparative Example 8. Therefore, using the configuration of Comparative Example 9, it is not possible to sufficiently improve the contrast in an ON-ON switching mode liquid crystal display device.

### Comparative Example 11

The contrast was 410, and the normalized luminance during black display was 99%. These results indicate that the difference in voltage between the various electrodes during black display has not been optimized, and that it is not possible to sufficiently prevent light leakage during black display; thus, there will be a drop in the contrast. Therefore, using the configuration of Comparative Example 11, it is not possible to sufficiently improve the contrast in an ON-ON switching mode liquid crystal display device.

### Comparative Example 12

The contrast was 187, and the normalized luminance during black display was 213%. These results indicate that the difference in voltage between the various electrodes during black display has not been optimized, and that it is not possible to sufficiently prevent light leakage during black display; thus, there will be a drop in the contrast. Therefore, using the configuration of Comparative Example 12, it is not possible to sufficiently improve the contrast in an ON-ON switching mode liquid crystal display device.

<Evaluation Results: Director Distribution, Transmittance Distribution, and Electric Field Distribution During Black Display>

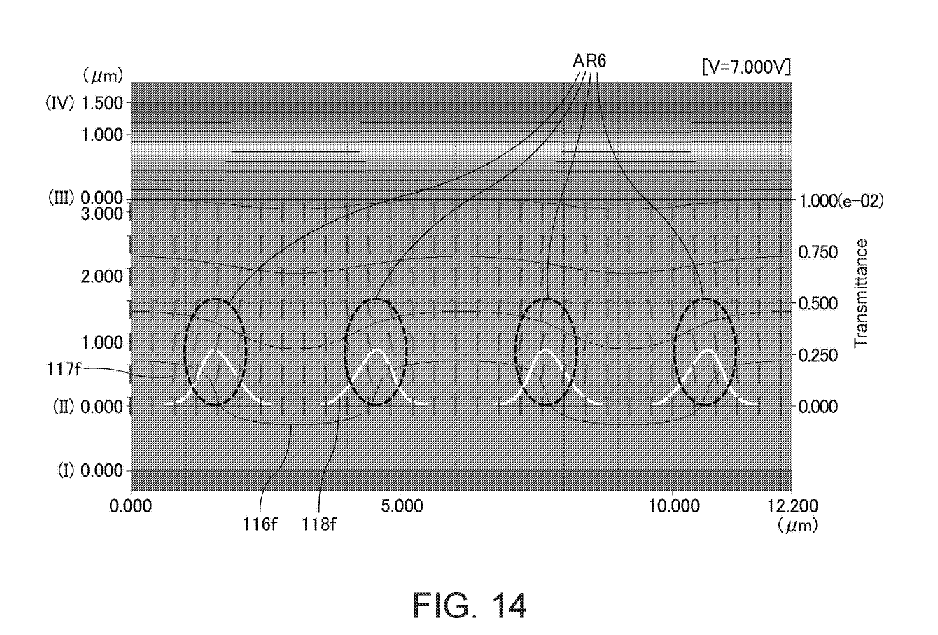

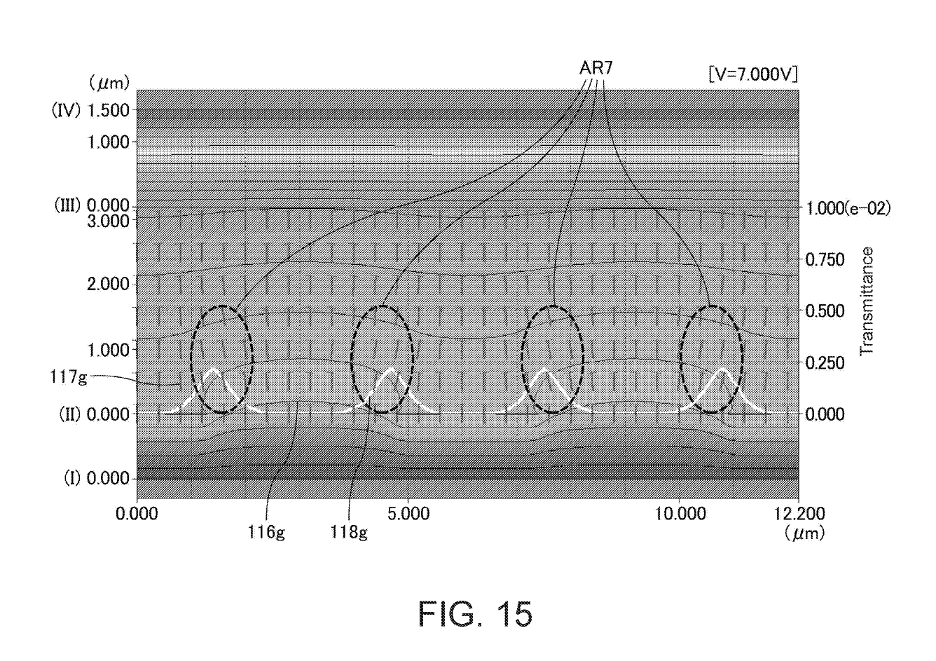

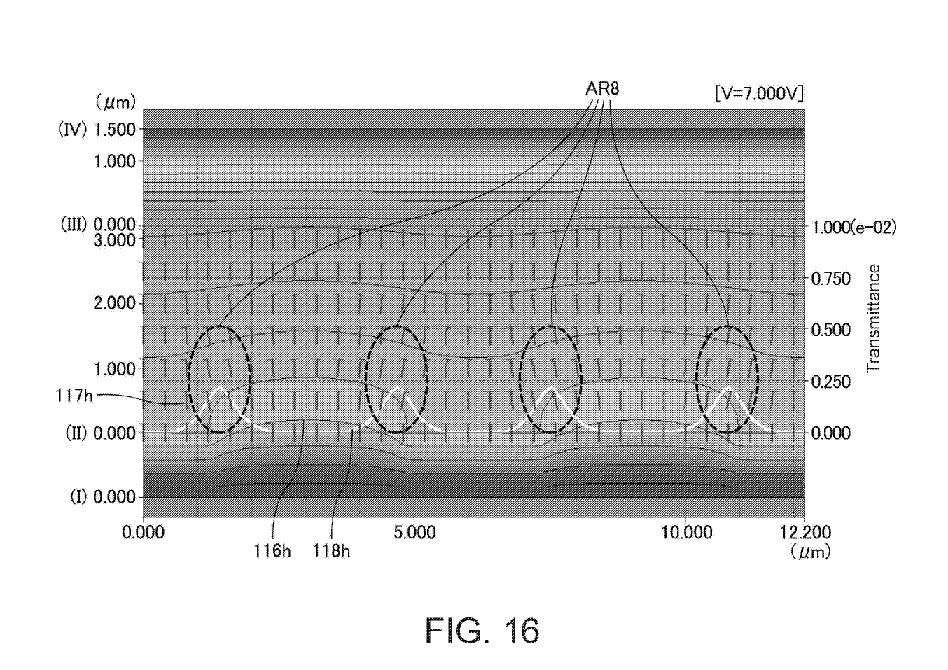

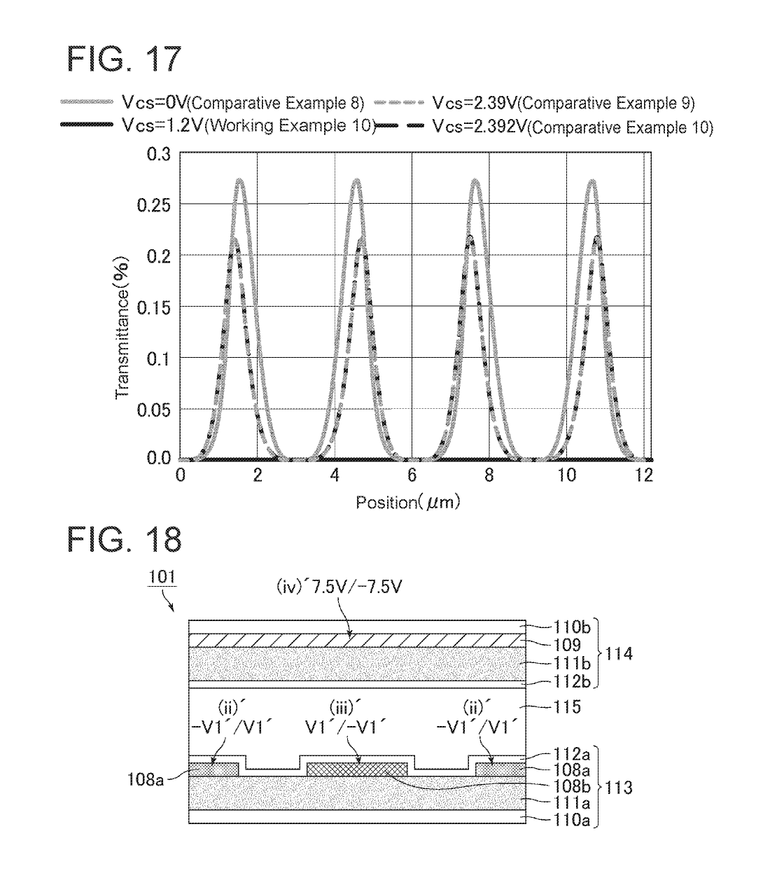

FIGS. 14 to 16 show the simulation results for the director distribution, the transmittance distribution, and the electric field distribution (equipotential surface) during black display for the liquid crystal display devices of Comparative Examples 8 to 10. FIG. 14 shows the director distribution, the transmittance distribution, and the electric field distribution during black display for the liquid crystal display device according to Comparative Example 8. FIG. 15 shows the director distribution, the transmittance distribution, and the electric field distribution during black display for the liquid crystal display device according to Comparative Example 9. FIG. 16 shows the director distribution, the transmittance distribution, and the electric field distribution during black display for the liquid crystal display device according to Comparative Example 10. The simulations shown in FIGS. 14 to 16 were conducted using an LCD Master manufactured by Shintech Inc. FIG. 17 is a graph that superimposes the transmittance distributions from FIGS. 14 to 16 on one another. The transmittance distribution during black display for Working Example 10 is also shown in the graph. FIG. 17 shows the transmittance distribution during black display of the liquid crystal display devices according to Working Example 10 and Comparative Examples 8 to 10.

The correspondence between the values shown on the horizontal axis, the left vertical axis, and the right vertical axis in FIGS. 14 to 16 and the location of respective members shown in FIG. 12 will be explained below. Looking at the horizontal axis in FIGS. 14 to 16, the values 0.000 μm to 1.300 μm represent a region where the left-hand portion of the comb-shaped electrode 8a exists, the values 1.300 μm to 4.800 μm represent a region between the left-hand portion of the comb-shaped electrode 8a and the comb-shaped electrode 8b, the values 4.800 μm to 7.400 μm represent a region where the comb-shaped electrode 8b exists, the values 7.400 μm to 10.900 μm represent a region between the comb-shaped electrode 8b and the right-hand portion of the comb-shaped electrode 8a, and the values 10.900 μm to 12.200 μm represent a region where the right-hand portion of the comb-shaped electrode 8a exists. Looking at the left vertical axis in FIGS. 14 to 16, (I) 0.000 μm is the location of the interface of the common electrode 7 and the insulating layer 11a, (II) 0.000 μm is the location of the interface of the insulating layer 11a and the liquid crystal layer 15 (the interface of the insulating layer 11a and the pair of comb-shaped electrodes 8a, 8b), (III) 0.000 μm is the location of the interface of the liquid crystal layer 15 and the insulating layer 11b, and (IV) 1.500 μm is the location of the interface of the insulating layer 11b and the opposite electrode 9. At (II) 0.000 μm and (III) 0.000 m, the thickness of the horizontal alignment films 12a, 12b is negligible; thus, these two locations are substantially the location of the interface of the insulating layer 11a and the liquid crystal layer 15 (the interface of the insulating layer 11a and the pair of comb-shaped electrodes 8a, 8b) and the location of the interface of the liquid crystal layer 15 and the insulating layer 11b, respectively. The right vertical axis in FIGS. 14 to 16 represents transmittance. The director distribution, the transmittance distribution, and the electric field distribution (equipotential surface) during black display were simulated over a region corresponding to the values 0.000 μm to 12.200 μm on the horizontal axis in FIGS. 14 to 16 for the liquid crystal display devices of Comparative Examples 8 to 10.

Evaluation results of the director distribution, the transmittance distribution, and the electric field distribution during black display for the various examples will be explained below.

### Comparative Example 8

FIG. 14 is a simulation of an electric field distribution (equipotential surface) 116f, a distribution of directors 117f, and a transmittance distribution 118f for a black display state in the liquid crystal display device 1b shown in FIG. 12 in which the applied voltage (i) of the common electrode 7 is set to 0V, the applied voltages (ii), (iii) of the pair of comb-shaped electrodes 8a, 8b are respectively set to 0V (black display), and the applied voltage (iv) of the opposite electrode 9 is set to 7.0V (which corresponds to V=7.000V in FIG. 14).

As shown in FIG. 14, during black display, the equipotential surface between the comb-shaped electrode 8a and the comb-shaped electrode 8b is located lower (recessed toward the insulating layer 11a) than the equipotential surface above the pair of comb-shaped electrodes 8a, 8b. Thus, the vertical electric field between the lower substrate 13 and the upper substrate 14 is not applied uniformly in Comparative Example 8. As a result, an oblique electric field component is generated, and as shown by regions AR6, the liquid crystal molecules located near the edges of the pair of comb-shaped electrodes 8a, 8b rotate. Therefore, as can be seen from the transmittance distributions shown in FIG. 17, light leakage near the edges of the pair of comb-shaped electrodes 8a, 8b is not sufficiently suppressed in Comparative Example 8 compared to Working Example 10.

### Comparative Example 9

FIG. 15 is a simulation of an electric field distribution (equipotential surface) 116g, a distribution of directors 117g, and a transmittance distribution 118g for a black display state in the liquid crystal display device 1b shown in FIG. 12 in which the applied voltage (i) of the common electrode 7 is set to −2.39V, the applied voltages (ii), (iii) of the pair of comb-shaped electrodes 8a, 8b are respectively set to 0V (black display), and the applied voltage (iv) of the opposite electrode 9 is set to 7.0V (which corresponds to V=7.000V in FIG. 15).

As shown in FIG. 15, during black display, the equipotential surface between the comb-shaped electrode 8a and the comb-shaped electrode 8b is located higher (rising toward the liquid crystal layer 15) than the equipotential surface above the pair of comb-shaped electrodes 8a, 8b. Thus, the vertical electric field between the lower substrate 13 and the upper substrate 14 is not applied uniformly in Comparative Example 9. As a result, an oblique electric field component is generated, and as shown by regions AR7, the liquid crystal molecules located near the edges of the pair of comb-shaped electrodes 8a, 8b rotate. Therefore, as can be seen from the transmittance distributions shown in FIG. 17, light leakage near the edges of the pair of comb-shaped electrodes 8a, 8b is not sufficiently suppressed in Comparative Example 9 compared to Working Example 10.

### Comparative Example 10

FIG. 16 is a simulation of an electric field distribution (equipotential surface) 116h, a distribution of directors 117h, and a transmittance distribution 118h for a black display state in the liquid crystal display device 1b shown in FIG. 12 in which the applied voltage (i) of the common electrode 7 is set to −2.392V, the applied voltages (ii), (iii) of the pair of comb-shaped electrodes 8a, 8b are respectively set to 0V (black display), and the applied voltage (iv) of the opposite electrode 9 is set to 7.0V (which corresponds to V=7.000V in FIG. 16).

As shown in FIG. 16, during black display, the equipotential surface between the comb-shaped electrode 8a and the comb-shaped electrode 8b is located higher (rising toward the liquid crystal layer 15) than the equipotential surface above the pair of comb-shaped electrodes 8a, 8b. Thus, the vertical electric field between the lower substrate 13 and the upper substrate 14 is not applied uniformly in Comparative Example 10. As a result, an oblique electric field component is generated, and as shown by regions AR8, the liquid crystal molecules located near the edges of the pair of comb-shaped electrodes 8a, 8b rotate. Therefore, as can be seen from the transmittance distributions shown in FIG. 17, light leakage near the edges of the pair of comb-shaped electrodes 8a, 8b is not sufficiently suppressed in Comparative Example 10 compared to Working Example 10.

Furthermore, looking at the transmittance ratios during black display for Working Examples 8, 9, 11, and 12, as shown in Table 2, the luminance is lower and the contrast is higher during black display compared to Comparative Example 8. Thus, it is clear that, similar to Working Example 10, light leakage near the edges the pair of comb-shaped electrodes 8a, 8b has been sufficiently prevented in the above-mentioned working examples compared to Comparative Example 8.

The relationship among differences in voltage between the various electrodes during black display that can sufficiently improve contrast in the first liquid crystal display device of the present embodiment will be explained next. From the above-mentioned results, the vertical electric field between the first substrate and the second substrate is uniform during black display when the vertical electric field is uniform within the liquid crystal layer (near the edges of the comb-shaped electrodes, for example), which corresponds to a region in which the pair of comb-shaped electrodes do not exist. Such a case will be described below.

During black display, when the vertical electric field is uniform within the liquid crystal layer, which corresponds to a region in which the pair of comb-shaped electrodes do not exist, expression (4) below is satisfied, where Cₐ is a capacitance between the region in which the pair of comb-shaped electrodes do not exist (a region, as shown in FIG. 2, between the comb-shaped electrode 8a and the comb-shaped electrode 8b, for example) and the first planar electrode (the common electrode 7 shown in FIG. 2, for example), and C_{b} is a capacitance between a region in which the pair of comb-shaped electrodes do not exist and the second planar electrode (the opposite electrode 9 shown in FIG. 2, for example). In addition, expression (5) is obtained by modifying expression (4) shown below.

$$\begin{matrix}< Formula 5 > & \\ {C}_{a} {V}_{a} = {C}_{b} {V}_{b} & ( 4 ) \\ < Formula 6 > & \\ {V}_{a} = \frac{{C}_{b}}{{C}_{a}} {V}_{b} & ( 5 )\end{matrix}$$

Cₐ and C_{b} are respectively defined in expressions (6) and (7) shown below. For ease of explanation, the area corresponding to a portion that forms Cₐ and C_{b} is set to 1. In addition, since the thickness of the vertical alignment films 12a, 12b shown in FIG. 2 is negligible, the vertical alignment films are not included in the first and second dielectric layers in expressions (6) and (7), for example.

$$\begin{matrix}< Formula 7 > & \\ {C}_{a} = \frac{{ɛ}_{1}}{{d}_{1}} & ( 6 ) \\ < Formula 8 > & \\ {C}_{b} = \frac{{ɛ}_{‖} {ɛ}_{2}}{{ɛ}_{2} {d}_{LC} + {ɛ}_{‖} {d}_{2}} & ( 7 )\end{matrix}$$

Thus, as a result of expressions (5), (6), and (7) shown above, the relationship between Vₐ and V_{b} satisfies expression (8), or in other words, satisfies expression (2). At such time, the vertical electric field is applied in a substantially uniform manner within the liquid crystal layer, leading to the maximum contrast. In other words, it is preferable that the relationship between Vₐ and V_{b} satisfy expression (8) below (the above-mentioned expression (2)) in a first liquid crystal display device of the present invention. This makes it possible to sufficiently increase the contrast. In addition, at such time, Vₐ is set to Vₐ_{_}₀₀.

$$\begin{matrix}< Formula 9 > & \\ {V}_{a} = \frac{{ɛ}_{‖} {ɛ}_{2} {d}_{1}}{{ɛ}_{1} {ɛ}_{2} {d}_{LC} + {ɛ}_{1} {ɛ}_{‖} {d}_{2}} {V}_{b} ( = {V}_{a \_ 0} ) & ( 8 )\end{matrix}$$

<Evaluation Results: Calculation Results of Expression (8)>

The calculation results of expression (8) for Embodiments 1 and 2 will be explained below.

### Embodiment 1

As mentioned above, in Embodiment 1, ∈_{∥} is 19.8, d_{LC} is 3.21 μm, ∈₁ is 3.2 μm, d₁ is 0.35 μm, ∈₂ is 3.2 μm, and d₂ is 1.53 μm. In addition, the applied voltages (ii), (iii) shown in FIG. 2 for the pair of comb-shaped electrodes 8a, 8b are respectively 0V during black display; thus, V_{b} in FIG. 2 is 7.5V. In addition, Vₐ in FIG. 2 is equal to V_{cs}.

Using these values and expression (8), Vₐ_{_}₀=1.2812 . . . , or approximately 1.3V, in Embodiment 1. As shown in FIG. 3, in Embodiment 1, the highest contrast is obtained at approximately V_{cs}=1.3V (Working Example 4), for example, thus proving that expression (8) is accurate.

In addition, 2Vₐ_{_}₀ is approximately 2.562V. Taking into consideration the evaluation results shown in FIG. 3, the contrast is sufficiently improved for the range of values that satisfy expression (1) compared to cases in which Vₐ=0V (V_{cs}=0V: Comparative Example 1).

<Formula 10>

0<|Vₐ|<2|Vₐ_{_}₀|−0.1 (1)

### Embodiment 2

In Embodiment 2, the values for ∈_{|}, d_{LC}, ∈₁, d₁, ∈₂, and d₂ are the same as those mentioned above for Embodiment 1. Since the applied voltages (ii), (iii) for the pair of comb-shaped electrodes 8a, 8b are 0V during black display, V_{b} in FIG. 12 is 7.0V. In addition, Vₐ in FIG. 12 is equal to V_{cs}.

Using these values and expression (8), Vₐ_{_}₀=1.1958 . . . , or approximately 1.2V, in Embodiment 2. As shown in FIG. 13, in Embodiment 2, the highest contrast is obtained at approximately V_{cs}=1.2V (Working Example 10), for example, thus proving that expression (8) is accurate.

In addition, 2Vₐ_{_}₀ is approximately 2.392V. Taking into consideration the evaluation results shown in FIG. 13, contrast is sufficiently improved for the range of values that satisfy expression (1) compared to cases in which Vₐ=0V (V_{cs}=0V: Comparative Example 8).

<Formula 11>

0<|Vₐ|<2|Vₐ_{_}₀|−0.1 (1)

The relationship among differences in voltage between the various electrodes during black display that can sufficiently improve contrast in the second liquid crystal display device of the present embodiment will be explained next. The second liquid crystal display device of the present invention is identical to the first liquid crystal display device of the present invention, except that the second dielectric layer does not exist. Thus, d₂ should be set to 0 μm in expression (8).

Thus, as a result of expression (8), the relationship between Vₐ and V_{b} satisfies expression (9) below, or in other words, satisfies the above-mentioned expression (3). At such time, the vertical electric field is applied in a substantially uniform manner within the liquid crystal layer, leading to the maximum contrast. In other words, it is preferable that the relationship between Vₐ and V_{b} satisfy expression (9) below (the above-mentioned expression (3)) in a second liquid crystal display device of the present invention. This makes it possible to sufficiently increase the contrast. In addition, at such time, Vₐ is set to Vₐ_{_}₀.

$$\begin{matrix}< Formula 12 > & \\ {V}_{a} = \frac{{ɛ}_{‖} {d}_{1}}{{ɛ}_{1} {d}_{LC}} {V}_{b} ( = {V}_{a \_ 0} ) & ( 9 )\end{matrix}$$

In addition, expression (9) is expression (8) in which d₂ has been set to 0 μm. Thus, as in the first liquid crystal display device of the present invention, contrast can be sufficiently improved in the second liquid crystal display device of the present invention for the range of values that satisfy expression (1) compared to instances in which Vₐ=0V.

<Formula 13>

0<|Vₐ|<2|Vₐ_{_}₀|−0.1 (1)

<Addendum>

Preferred configurations of the liquid crystal display device of the present invention will be given below. The respective configurations mentioned above may be appropriately combined within a scope that does not depart from the gist of the present invention.

The liquid crystal molecules included in the liquid crystal layer may be oriented in a direction perpendicular to the main surfaces of the first and second substrates when no voltage is being applied.

In order to realize such a liquid crystal display device of a vertical orientation type, it is preferable that the first and second substrates have vertical alignment films, for example. A vertical alignment film is an alignment film that aligns the liquid crystal molecules in a direction perpendicular to the main surfaces of the substrates when no voltage is being applied, and various types of alignment treatment may be performed. Examples of methods of such alignment treatment include rubbing, photoalignment, and the like. Since the thickness of the vertical alignment film is negligible, the first and second dielectric electric layers are not included in the calculation of expressions (2) and (3).

Such a vertical alignment liquid crystal display device is advantageous in obtaining properties such as a wide viewing angle and high contrast. Thus, when the liquid crystal display device of the present invention is a vertical alignment liquid crystal display device, it is possible to realize a wide viewing angle and high contrast. The phrase “when voltage is not being applied” should refer to times when it can be said in the technical field of the present invention that voltage is not being substantially applied. In addition, the phrase “oriented in a direction perpendicular to the main surfaces of the first and second substrates” includes being oriented in a substantially perpendicular direction, as long as it can be said in the technical field of the invention that the liquid crystal molecules are oriented in a direction perpendicular to the main surfaces of the first and second substrates.

The first and second planar electrodes may be AC driven by voltages of opposite polarity. In this manner, it is possible to suitably drive the liquid crystal display device of the present invention and sufficiently improve contrast.

At least one of the first substrate and second substrate may further include a thin film transistor element, and the thin film transistor element may have a semiconductor layer that includes an oxide semiconductor.

The above-mentioned oxide semiconductor has higher mobility and less characteristic variation than amorphous silicon. As a result, thin film transistor elements that include an oxide semiconductor have a high driving frequency and can be driven at a faster speed than thin film transistor elements that include amorphous silicon, and a smaller number of transistor elements need to be used for one pixel. Therefore, such transistor elements are suitable for driving next generation display devices which have higher resolution. Furthermore, an oxide semiconductor film is formed by a process that is simpler than that for a polycrystalline silicon film, and thus, the oxide semiconductor film can also be applied to devices requiring a large area. Thus, when thin film transistor elements included in the liquid crystal display device of the present invention have a semiconductor layer including an oxide semiconductor, the thin film transistor elements exhibit the effect of the present invention and can realize an even faster driving speed.

Furthermore, the oxide semiconductor may be formed of: a compound (In—Ga—Zn—O) formed of indium (In), gallium (Ga), zinc (Zn), and oxygen (O); a compound (In-Tin-Zn—O) formed of indium (In), tin, zinc (Zn), and oxygen (O); a compound (In—Al—Zn—O) formed of indium (In), aluminum (Al), zinc (Zn), and oxygen (O); or the like, for example.

The first and/or second dielectric layer may have a stacked structure formed of a plurality of components having different compositions. When the first dielectric layer has a stacked structure formed of a first component and a second component, the permittivity ∈₁ and the thickness d₁ of the first dielectric layer are represented by expressions (10) and (11) shown below, for example.

$$\begin{matrix}< Formula 14 > & \\ {ɛ}_{1} = \frac{{ɛ}_{1 a} {ɛ}_{1 b} ( {d}_{1 a} + {d}_{1 b} )}{{ɛ}_{1 a} {d}_{1 b} + {ɛ}_{1 b} {d}_{1 a}} & ( 10 )\end{matrix}$$

In expression (10), ∈₁ₐ is the permittivity of the first component, ∈_{1b} is the permittivity of the second component, d₁ₐ is a thickness (units: μm) of the first component, and d_{1b} is a thickness (units: μm) of the second component.

<Formula 15>

d₁=d₁ₐ+d_{1b} (11)

In expression (11), d₁ₐ is the thickness (units: μm) of the first component, and d_{1b} is the thickness (units: μm) of the second component.

Expressions (10) and (11) are used in instances in which the first dielectric layer has a stacked structure formed of two components (a first component and a second component). Even in cases in which the dielectric layer has a stacked structure formed of three or more components, however, the permittivity ∈₁ and the thickness d₁ of the first dielectric layer is calculated in a similar manner using the permittivity and thickness of the various components. In addition, when the second dielectric layer has a stacked structure formed of a plurality of components of differing composition, the permittivity ∈₂ and the thickness d₂ of the second dielectric layer is calculated using the permittivity and thickness of the various components, just as for the first dielectric layer.

The pair of comb-shaped electrodes may be AC driven by applying voltages of the same absolute value at opposite polarities. In this manner, it is possible to suitably drive the liquid crystal display device of the present invention and sufficiently improve contrast.

One of the first and second substrates may be an active matrix substrate including a thin film transistor element, while the other substrate may be a color filter substrate including a color filter. It is preferable that the thin film transistor element and the color filter be formed on main surfaces of insulating substrates. It is preferable to use a transparent substrate such as a glass substrate or a plastic substrate as the insulating substrates. Furthermore, when a color filter substrate is used, it is preferable that an overcoat layer be disposed on the color filter in order to maintain the vertical electric field.

The liquid crystal display device may further include a polarizing plate, and the polarizing plate may be a linearly polarizing plate. As a result, it is possible to further improve the uniformity in viewing angle characteristics. There are no particular restrictions regarding the type or structure of the linearly polarizing plate, and any plate normally used in the technical field of the present invention can be used.

The liquid crystal display device may further include a polarizing plate, and the polarizing plate may be a linearly polarizing plate. As a result, the transmittance can be improved. There are no particular restrictions regarding the type or structure of the circularly polarizing plate, and any plate normally used in the technical field of the invention can be used.

### DESCRIPTION OF REFERENCE CHARACTERS

| | |
|---|---|
| 1a, 1b, 101 | liquid crystal display |
| | device |
| 2 | pixel |
| 3 | gate bus line |
| 4a, 4b | source bus line |
| 5a, 5b | thin film transistor |
| | element |
| 6a, 6b | contact hole |
| 7, 107 | common electrode |
| 8a, 8b, 108a, 108b | comb-shaped |
| | electrode |
| 9, 109 | opposite electrode |
| 10a, 10b, 110a, 110b | supporting substrate |
| 11a, 11b, 111a, 111b | insulating layer |
| 12a, 12b, 112a, 112b | vertical alignment |
| | film |
| 13, 113 | lower substrate |
| 14, 114 | upper substrate |
| 15, 115 | liquid crystal layer |
| 16a, 16b, 116a, 116b, 116c, 116d, | electric field |
| 116e, 116f, 116g, 116h, 116i | distribution (equipotential surface) |
| 17a, 17b, 117a, 117b, 117c, 117d, | director |
| 117e, 117f, 117g, 117h, 117i | |
| 18a, 18b, 118a, 118b, 118c, 118d, | transmittance |
| 118e, 118f, 118g, 118h, 118i | distribution |

1. A liquid crystal display device, comprising:
a first substrate;
a second substrate facing the first substrate; and
a liquid crystal layer sandwiched between the first substrate and the second substrate,
wherein the first substrate has thereon a first planar electrode, a first dielectric layer on the first planar electrode, and a pair of comb-shaped electrodes on the first dielectric layer, an additional dielectric layer being essentially absent between the liquid crystal layer and the pair of comb-shaped electrodes and between the liquid crystal layer and the first dielectric layer,
wherein the second substrate has thereon a second planar electrode and a second dielectric layer on the second planar electrode, an additional dielectric layer being essentially absent between the second dielectric layer and the liquid crystal layer,
wherein the liquid crystal layer includes liquid crystal molecules having a positive dielectric anisotropy, and
wherein the liquid crystal display device is configured such that, when displaying a minimum gradation, a same voltage is applied to the pair of comb-shaped electrodes, and a relationship among voltages applied to the first planar electrode, the pair of comb-shaped electrodes, and the second planar electrode satisfies the following expressions (1) and (2):
$$\begin{matrix}0 < \vert {V}_{a} \vert < 2 \vert {V}_{a \_ 0} \vert - 0.1 & ( 1 ) \\ {V}_{a \_ 0} = \frac{{ɛ}_{‖} {ɛ}_{2} {d}_{1}}{{ɛ}_{1} {ɛ}_{2} {d}_{LC} + {ɛ}_{1} {ɛ}_{‖} {d}_{2}} {V}_{b} & ( 2 )\end{matrix}$$
where Vₐ (unit: V) is a voltage differential between the voltage of the first planar electrode and the voltage of the pair of comb-shaped electrodes, V_{b} (unit: V) is a voltage differential between the voltage of the pair of comb-shaped electrodes and the voltage of the second planar electrode, ∈₁ is a permittivity of the first dielectric layer, ∈₂ is a permittivity of the second dielectric layer, ∈₁ is a permittivity in a direction that is horizontal with respect to a director of the liquid crystal molecules included in the liquid crystal layer, d₁ is a thickness (unit: μm) of the first dielectric layer, d₂ is a thickness (unit: μm) of the second dielectric layer, and d_{LC} is a thickness (unit: μm) of the liquid crystal layer.

2. A liquid crystal display device, comprising:
a first substrate;
a second substrate facing the first substrate; and
a liquid crystal layer sandwiched between the first substrate and the second substrate,
wherein the first substrate has thereon a first planar electrode, a first dielectric layer on the first planar electrode, and a pair of comb-shaped electrodes on the first dielectric layer, an additional dielectric layer being essentially absent between the liquid crystal layer and the pair of comb-shaped electrodes and between the liquid crystal layer and the first dielectric layer,
wherein the second substrate has thereon a second planar electrode, a dielectric layer being essentially absent between the second planar electrode and the liquid crystal layer,
wherein the liquid crystal layer includes liquid crystal molecules having a positive dielectric anisotropy, and
wherein the liquid crystal display device is configured such that, when displaying a minimum gradation, a same voltage is applied to the pair of comb-shaped electrodes, and a relationship among voltages applied to the first planar electrode, the pair of comb-shaped electrodes, and the second planar electrode satisfies the following expressions (1) and (2):
$$\begin{matrix}0 < \vert {V}_{a} \vert < 2 \vert {V}_{a \_ 0} \vert - 0.1 & ( 1 ) \\ {V}_{a \_ 0} = \frac{{ɛ}_{‖} {d}_{1}}{{ɛ}_{1} {d}_{LC}} {V}_{b} & [ [ ( 3 ) ] ] ( 2 )\end{matrix}$$
where Vₐ (unit: V) is a voltage differential between the voltage of the first planar electrode and the voltage of the pair of comb-shaped electrodes, V_{b} (unit: V) is a voltage differential between the voltage of the pair of comb-shaped electrodes and the voltage of the second planar electrode, ∈₁ is a permittivity of the first dielectric layer, ∈_{∥} is a permittivity in a direction that is horizontal with respect to a director of the liquid crystal molecules included in the liquid crystal layer, d₁ is a thickness (unit: μm) of the first dielectric layer, and d_{LC} is a thickness (unit: μm) of the liquid crystal layer.

3. The liquid crystal display device according to claim 1, wherein the liquid crystal molecules included in the liquid crystal layer are oriented in a direction perpendicular to respective main surfaces of the first substrate and the second substrate when no voltage is being applied.

4. The liquid crystal display device according to claim 1, wherein the first planar electrode and the second planar electrode are AC-voltage driven with polarities opposite to each other.

5. The liquid crystal display device according to claim 1,
wherein at least one of the first substrate and the second substrate further includes a thin film transistor element, and
wherein said thin film transistor element includes a semiconductor layer having an oxide semiconductor.

6. The liquid crystal display device according to claim 2, wherein the liquid crystal molecules included in the liquid crystal layer are oriented in a direction perpendicular to respective main surfaces of the first substrate and the second substrate when no voltage is being applied.

7. The liquid crystal display device according to claim 2, wherein the first planar electrode and the second planar electrode are AC-voltage driven with polarities opposite to each other.

8. The liquid crystal display device according to claim 3, wherein the first planar electrode and the second planar electrode are AC-voltage driven with polarities opposite to each other.

9. The liquid crystal display device according to claim 6, wherein the first planar electrode and the second planar electrode are AC-voltage driven with polarities opposite to each other.

10. The liquid crystal display device according to claim 2,
wherein at least one of the first substrate and the second substrate further includes a thin film transistor element, and
wherein said thin film transistor element includes a semiconductor layer having an oxide semiconductor.

11. The liquid crystal display device according to claim 3,
wherein at least one of the first substrate and the second substrate further includes a thin film transistor element, and
wherein said thin film transistor element includes a semiconductor layer having an oxide semiconductor.

12. The liquid crystal display device according to claim 4,
wherein at least one of the first substrate and the second substrate further includes a thin film transistor element, and
wherein said thin film transistor element includes a semiconductor layer having an oxide semiconductor.

13. The liquid crystal display device according to claim 6,
wherein at least one of the first substrate and the second substrate further includes a thin film transistor element, and
wherein said thin film transistor element includes a semiconductor layer having an oxide semiconductor.

14. The liquid crystal display device according to claim 7,
wherein at least one of the first substrate and the second substrate further includes a thin film transistor element, and
wherein said thin film transistor element includes a semiconductor layer having an oxide semiconductor.

15. The liquid crystal display device according to claim 8,
wherein at least one of the first substrate and the second substrate further includes a thin film transistor element, and
wherein said thin film transistor element includes a semiconductor layer having an oxide semiconductor.

16. The liquid crystal display device according to claim 9,
wherein at least one of the first substrate and the second substrate further includes a thin film transistor element, and
wherein said thin film transistor element includes a semiconductor layer having an oxide semiconductor.
